(19) United States
(12) Patent Application Publication
(10) Pub. No.: US 2014/0139455 A1
(43) Pub. Date: May 22, 2014

(54) ADVANCING THE WIRED AND WIRELESS CONTROL OF ACTIONABLE TOUCHSCREEN INPUTS BY VIRTUE OF INNOVATIVE ATTACHMENT-AND-ATTACHMENTLESS CONTROLLER ASSEMBLIES: AN APPLICATION THAT BUILDS ON THE INVENTOR'S KINDRED SUBMISSIONS

(71) Applicant: Chris Argiro, Toronto (CA)

(72) Inventor: Chris Argiro, Toronto (CA)

(21) Appl. No.: 14/021,768

(22) Filed: Sep. 9, 2013

Related U.S. Application Data
(60) Provisional application No. 61/702,721, filed on Sep. 18, 2012.

(51) Int. Cl. G06F 3/041

(52) U.S. Cl. CPC G06F 3/0412
USPC 345/173

(57) ABSTRACT

The application serves an eclectic mix of both wired (such as using a wired attachment interface for mapping an actionable object) and wireless (a system of attachmentless actuation ushered by software mapping) touchscreen controllers in an impetus to build on the inventor's previous discourse and to further highlight a continued theme of touchscreen controller innovation with this latest application entry. The inventor herein seeks to further revolutionize the face of touchscreen gaming by continuing with the theme of disclosing innovative touchscreen controller interfaces, and in so doing, the disclosure again attempts to quash many of the traditional limitations associated with a touchscreen's typical user interface; even introducing innovative serviceable User Interfaces that helps blur the lines of usability between touchscreen devices and competing platforms. A further injection of atypical controller interfaces are herein disclosed by the inventor in a continued attempt to break free from traditional applications.

### RELATIONSHIP TO OTHER APPLICATIONS

This application is a continuation of U.S. patent application Ser. No. 13/720,855 as filed on Dec. 19, 2012; which is a continuation of United States Patent Application 20120319989 filed on Sep. 29, 2011 which borrows from the disclosure of Provisional Application No. 61/499,172 as filed on Jun. 20, 2011. Application Ser. No. 14/021,768 is an extension of Provisional Application No. 61/702,721 as filed on Sep. 18, 2012. Furthermore, the application is a kindred extension to the inventor's prior submissions in the field (all under common ownership) and claims full benefits of a list of intellectual property that includes 61/282,692 and 61/344,158 with The USPTO; U.S. Pat. No. 8,368,662 (with the prior art date of Mar. 18, 2010), particularly, and utility application Ser. Nos. 13/005,315 and 13/249,194 with The USPTO and International applications PCT/IB2011/051049 and PCT/IB2012/052125 under PCT WIPO; all applications are to be incorporated by reference herein, in their entirety, for all purposes. Certain content comprising this utility application may further serve as specification, illustration and claims' fodder for an imminent divisional application highlighting a distinct body of invention.

### BACKGROUND OF THE INVENTION

Inherent limitations attributed to traditional touchscreen input birth an inventive opportunity for addressable innovation. The present invention seeks to revolutionize the interface and exchange between touchscreen technology, primarily, and an end user of said touchscreen technology. Both attachment-based and attachmentless interfaces are presented for an encompassing brush stroke of inventive fodder for the field of touchscreen-based controller environments;

### SUMMARY

Embodiments herein are directed to systems, devices and methods for improving the control functionality of soft buttons displayed on congruous touchscreens. In addition, embodiments herein are, amongst other directives, directed to systems, devices and methods for expanding the method and breadth of serviceable interaction between a user device and user. Innovative controller assemblies herein seek to build on the inventive fodder of the inventor's kindred submissions with the common building block of revolutionizing the input-delivery system for touchscreen-based devices. The present invention, in part, in an inventive and sequent brush stroke, seeks to ideally lift a touchscreen user device from restraints associated with its traditional use and associative protocol; or functional role, into a device that assumes more of the characteristics of a gaming console, complete with interactive capability amongst a participating touchscreen device and the revolutionary (and liberating) touchscreen controllers—introduced by the inventor and further, those controllers made possible through his associative teachings—seeking to exert their influence upon said device.

A plurality of suspension apparatus are disclosed that empower the user through tactile representation and engagement of summoned soft-button counterparts, from a position remote to said soft-button counterparts by virtue of an attachment interface, such as that assigned (in positioning, in accordance with an embodiment) adjacent to the glass surface of a touchscreen on an outlined border, or proximally to the bordering edges of an active touchscreen or, adding to the embodiment diversity, an attachment interface associated with a controller handle or handle plurality. A gyroscopic apparatus that nests a user device and is approximately prone to the influence of gyroscopic manipulation (in a reflex manner) of a remote control influence, is further suggested. The gyroscopic apparatus may be further combined with an intermediary-transceiver device and capacitive-discharge overlay seeking attachment for the intended and added purpose of manipulating onscreen actionable objects. A camera-driven tracking “plotter”, comprising an intermediary-transceiver device that manages and supplies a capacitive load to a stationed touchscreen device by virtue of an attachable capacitive-discharge overlay, based on the coordinate tracking present by said camera ascertainment, is disclosed. Relatedly, a layered transparent-attachment overlay—strategically channelling a quantity of capacitive input to an indium-tin oxide coating for respective capacitive discharge to a touchscreen—is described. A transitioned mouse and touchpad-input device designed for touchscreens, along with a docking system, is discussed that further build on the principles disclosed in the introduction of the layered-transparent attachment overlay. Alternatively, a mouse-like input medium is described that relies on gesture-recognition derived from innate camera-tracking and not the influence of a physical (hardware) mouse or touchpad. An attachmentless-transceiver device with a cradle system further punctuates the liberation of control input in a touchscreen environment, as spirited by the present inventive fodder.

A wireless controller with attachmentless mapping by virtue of pairing app is further presented. A “surround-sense” video and audio output system hosting both an attachment-based and attachmentless specialty guitar controller is discoursed; adding depth-perception refresh to a controller environment. Attempting to further broaden the way touchscreen controllers are viewed, a “micro-capture” or finite screen-capturing device by snapshot, for registry of a remote controller input influence by “line-of-sight” directives, additionally expands on the breadth of controller inputs discoursed by the inventor, with the bulk of iterations readily capable of proficient operation under an adaptive controller system subjecting a touchscreen to an attachable interface, by design, if so coveted.

Expanding further still, amusement-park or fun-park themed games such as skeet-ball, basketball-shootout, race-drive and mini-golf specialty controllers are transitioned to a touchscreen environment in both wireless and wired variants. And for those touchscreen users more business oriented; such as those looking to perform a data-entry task, engage in e-mail correspondence and/or manage alphanumeric text input in a time-sensitive office document, an expansive (and a retractable), pliant membrane (or lamella) is designed to sit elevated proximally above a touchscreen by a supportive structure for respective-actuation input (an “actionable” membrane for the actuation of an actionable object or object plurality displayed on a touchscreen upon the strategic depression of a finger input on the membrane) and lend cadence to a typing aid for virtual touchscreens. A hybrid radio-controller device with actionable touchscreen integration and a physical-intangible hybrid DJ-controller system (also a type of specialty input controller) are further discoursed in the embodying matter herein.

And according to some iterations, a touchscreen device is more centred as a hosting device of an app, than it is for its propensity to accept a capacitive input, which, according to said iterations and under the collective umbrella of the inventive discourse, may see the need for direct finger engagement to a capacitive screen become supplanted by virtue of, for instance, the direct integration of a wireless specialty controller input with a touchscreen user device via a communicable software program residing on the touchscreen user device as a case in point and/or by virtue of a physical communicable interface designed for actuation by attachment.

### BRIEF DESCRIPTION OF THE DRAWINGS

Images expressed in this application are for embodiment-based illustrative purposes only and are not suggestive of limitation, as products released to the market may differ widely from those illustrated in this writing whilst still remaining faithful to the spirit and scope of this discourse. Images are not necessarily to scale and do not suggest fixed construction and/or component composition.

According to the listed embodiments:

FIG. 1 is an illustration of a touchscreen-suspension device equipped with comfort grips and remote-control operability stemming from a tactile input controller (operating on the capacitive input of a finger) and a respectively conjoined attachable soft-button output interface or interface plurality (serving to strategically discharge the capacitive input or charge of a finger to, for instance, a targeted soft-button of a touchscreen upon attachment);

FIG. 1A illustrates a tactile interface: delineated by a capacitive-bearing button member or member plurality; communicably placed on the borders of a user device (that is, the area directly adjacent to a touchscreen) in contrast to a similarly spirited (in reference to a tactile interface being present) suspension device, shown in FIG. 1.

FIG. 2 is an illustration serving to broaden the embodiment of FIG. 1—complete with remote-control operability—whereas the comfort grips give way to a user-mounted support apparatus acting to suspend a user device automatically; that is, without the need for the user to actually clutch the user device to establish operable suspension.

FIG. 3A-B illustrates a mounting apparatus (a host device to which a touchscreen device is mounted) designed for omni-directional movement, including the potential for horizontal and vertical traversing at the attachment base, as engaged in a reflex response to a remote influence of an input controller.

FIG. 4 illustrates a capacitive-plotter device governed by the influence of a user's motion or motions; with said motion(s) or gestures being detected by a camera innate to a transceiver device or touchscreen device for purposes of translating the gesture(s) into corresponding actuation at a mapped domain.

FIGS. 5A-D illustrates a mouse-input device—a control input traditionally associated with a desktop environment—and assembly, including a layered transparent attachment overlay for touchscreens (an actionable layering) for serviceable use; as the core of mouse input functionality and its liberating utility are uniquely transitioned to a touchscreen environment, under a described method and assembly.

FIG. 5E illustrates a mouse-type input system that uses an associated camera to track a user's fingers (assuming and influencing the position of “mouse” pointer) across the screen with a recognized and programmable inventory of gestures available to the user for articulated gesture commands.

FIG. 6 illustrates a touchpad-based input device—the working environment of which is traditionally associated with desktops—as it is uniquely transitioned to a touchscreen environment, under a described method and assembly.

FIG. 7 illustrates an attachmentless-transceiver device with a cradle system capable of strategically delivering an innately-produced capacitive load directly to the soft-buttons and/or soft-input interface of a docked touchscreen device (without the need for an attachable output interface). Deliverance of said capacitive load (at a strategic point of touchscreen discharge) occurs by virtue of a grid-like assembly of relay nodes across the cradle face.

FIG. 7A illustrates a wireless controller and pairing app that can be integrated with or without use of an intermediary-transceiver device and attachment.

FIG. 8 illustrates a “surround-sense” display system (with video and audio output) comprising a primary television display and a secondary (surrounding) display structure designed to provide the user with additional visual depth and dimension; with the primary television display interacting with either an integrated attachmentless-transceiver or traditional intermediary-transceiver device with attachment, or both, to bolster interface integration.

FIGS. 9A-B illustrates a “surround-sense” display system (with video and audio output) comprising the primary output display of a user device and a secondary (surrounding) display structure designed to primarily provide the user with additional visual depth, perspective and dimension. According to this exemplary discourse, use of an integrated and attachmentless specialty controller system (a guitar prop, without suggesting of limitation, for integrated gaming) is introduced in direct wireless communication with a touchscreen user device to not only capably input control directives (with the touchscreen user device also acting as a primary display associated with the input directives as per an embodiment), but also to influence the content rendered onto the dual-screen's “peripheral-zone output”. Unlike the associative illustration in FIG. 8, as per the focus of this exemplary discourse, the primary output display—provided by a touchscreen user device—sits centrally suspended at the perimeter of the visual “zone” of the surrounding peripheral-display structure for greater visual convergence.

FIG. 10 illustrates a dock-connector system for the primary purpose of powering the determinant components of a small intermediary-transceiver device with camera. A capacitive-discharge overlay operates in collaboration with the small intermediary-transceiver device to strategically deploy (based on camera-tracked input gestures) a capacitive charge to a targeted domain on the touchscreen for related actuation.

FIG. 11 illustrates a “micro-capture” or (finite) screen-capturing device, an input controller, used for articulated touchscreen registration (by remote influence) of a communicable directive cast from said “line-of-sight” input controller.

FIG. 12 illustrates a physical skeet-ball controller (comprising a foldable case with handle for easy storage) integrated into a virtual setting, as the present invention transitions a skeet-ball controller to a touchscreen environment.

FIG. 13 illustrates a door-mounted, mini-basketball-net controller that is transitionally designed for touchscreen integration into a virtual-basketball environment; such as in pairing said controller with an app based on the rapid-shoot or “basketball-shootout” games present in arcades or amusement parks.

FIG. 14 illustrates a mini-golf pad controller system that is transitionally designed for touchscreen integration into a virtual-mini-golf environment.

FIG. 15 discloses a card-playing system, with a physical controller interface, deck presence and a mechanical distribution system, transitionally designed for touchscreen integration into a virtual-card-playing environment or virtual setting.

FIG. 16 illustrates a cylindrical tube, assuming the appearance of a fountain pen, that is incised in two proximate halves that easily separate and reattach to each other to form an assembled whole. Upon separation of the cylindrical tube (from an assembled whole) by virtue of a pulling agent, a retractable mechanism is presented. The retractable mechanism ushers a short, rolled length of flexible transparent material to a locked position between the two drawn proximate halves of the cylindrical tube. The two proximate halves seek secure and serviceable attachment to a touchscreen device and, upon attached engagement, serve as a typing aid for virtual touchscreen-keyboards.

FIG. 17 illustrates a hybrid radio-wave controller device with touchscreen user device integration for the allied control of a physical RC toy car in an enclosed track; with the added difficulty of having to manoeuvre around digital obstacles “injected” into the RC car's physical path as it is tracked on a digitally-refreshing touchscreen (acting as the user's “dashboard display”—a viewfinder of sorts, for integration of a physical car in a virtual environment) mounted to the radio-wave controller device.

FIG. 18 illustrates a wireless racing-wheel controller and coalescent audio/visual assembly transitionally designed for operational and integral use in a race-themed environment for touchscreen devices.

FIG. 19 illustrates a physical/virtual hybrid input controller system (a DJ-controller) utilizing both a physical-input controller mode and a gesture-seeking mapping component (an input mode based on the tracking of a user's gesture by virtue of the integrated camera of a user device) designed for bi-modal integration of a user input into a virtual environment being rendered on a remote touchscreen user device or device plurality.

### DETAILED DESCRIPTION

Embodiments herein are directed to systems, devices and methods for improving on and/or liberating the input function of soft-button controllers (graphical representations that are engaged by—or respond to—the control input of a finger in order to carry out a function, including all respective soft key(s) situated on, generally speaking, a capacitive touchscreen) and/or the input function of integrated sensors built into touchscreen user devices, particularly. In addition, embodiments herein are, amongst other directives, directed to systems, devices and methods for expanding the method and breadth of touch-input delivery for touchscreen systems through the introduction of (and any kindred controller scion based on its teachings) innovative, assistive-controller technologies. The disclosures herein are provided to lend instance to the operation and methodology of the various embodiments and are neither intended to suggest limitation in breadth or scope nor to suggest limitation to any appended claims. Furthermore, such exemplary embodiments may be applicable to all suitable touchscreen-hardware platforms (tablets, smart phones, monitors, televisions, point-of-display, etceteras) and can also include all suitable touchscreen technologies, beyond capacitive and capacitance governed, such as those inclined with resistive touchscreens that, too, respond to touch input, albeit with its own peculiarities related to the technology. Those skilled in the art will understand and appreciate the actuality of variations, combinations and equivalents of the specific embodiments, methods and examples listed herein.

In the discourse that follows, the terms “soft button” or “soft keys” may encompass a graphical representation of a D-pad (directional pad) or gamepad, a physical button, a switch, a pointer, an alphanumeric key, data-entry key or any input-seeking graphical representation on a touchscreen; that may be engaged by a user through touch in order to enter a command, indicate a selection, input data or engage control of an actionable object on a touchscreen. Touch gestures are registered by the touchscreen through the interpretation of an associated processor; generally, aligned with the respective software running on the touchscreen user device.

In the description that follows, the term “attachment” generally refers to a device or assembly that is assigned for associative contact with the soft-buttons on a touchscreen for purposes of engaging control of an actionable object or series of objects, such as those that may be present in gaming, enterprise, office suites, text or data-entry, media, graphics and presentation applications, although these applications are not suggestive of limitation. An attachment may be adapted for both wired and wireless expressions.

In the description that follows, attachment of a manipulable physical interface to a touchscreen's surface may be accomplished by virtue of leveraging the properties of suction, static, a removable, residue-free adhesive backing (e.g. by virtue of an applied coating) and/or gummy application and/or any other appropriate means.

The term “actuating agent”, with the spirit and scope of the IP discourse under common ownership of the inventor and beginning Mar. 18, 2010 yielding by example, may refer to a touchscreen-attachable conductive element that is physically tethered to an input by virtue of a serviceable conductive path; a path typically engaged by first manipulating a controller input (e.g. thus leading it to becoming capacitively charged) in a wired operation and/or, in accordance with a wireless complement, a software-based mapping complement is used to map the engagement of a controller input with a correlative soft input on a touchscreen device through the process of spiriting virtual actuation.

In the description that follows, the term “remote operation” refers to operational input that generally occurs remotely from the touchscreen. Embodiments of the present invention are described in more detail below, under dissertation of introduced figures, with reference to the accompanying drawings. While a functional element may be illustrated as being located within a particular structure, other locations of the functional element are possible. Further, the description of an embodiment and the orientation and layout of an element in a drawing are for illustrative purposes only and are not suggestive of limitation.

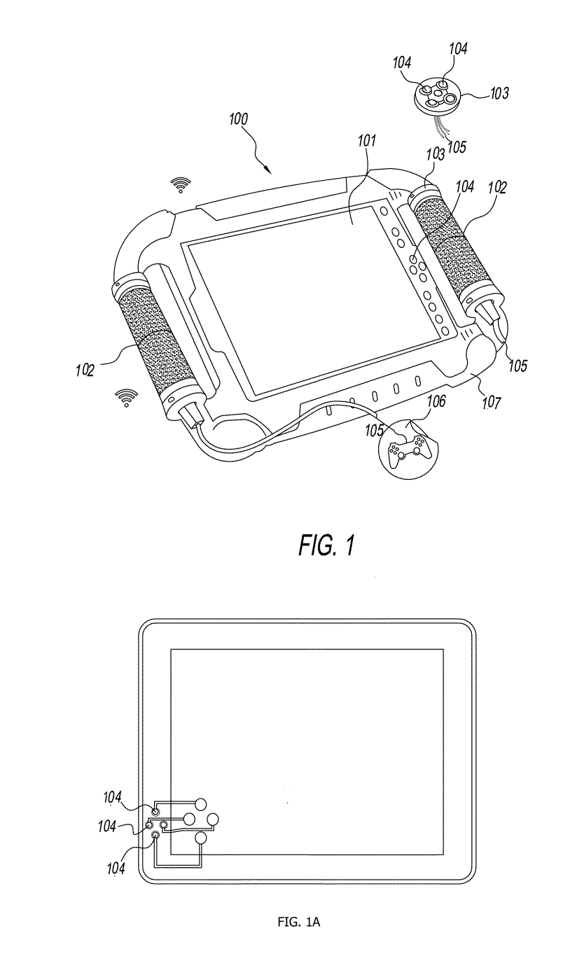

Referring now to the present invention in more detail, according to an embodiment, FIG. 1 depicts a touchscreen-suspension device 100 equipped with grippable-handle members 102 and an associated tactile controller (with buttons) 103 or controller plurality as shown—stemming from an insulated wire 105 tethering between each button member 104 of the tactile input controller 103 and each respective soft-button counterpart by means of an attachable (output) interface 106 or interface plurality at the wired 105 tether (or opposing) end (not the subject of illustration here). Direct wireless pairing with a user device 101 for purposes of controlling an actionable object may, of course, occur in a kindred embodiment.

A suspension device 100 comprises a receptive frame, designed to securely station a mountable touchscreen user device 101, and grippable-handle members 102 constructed at both ends of the frame structure. The grippable-handle member and/or handle member plurality 102 comprise(s) a tactile input interface 103; delineated by a capacitive-bearing button member or member plurality 104, the arrangement and positioning of which may vary widely from this illustration. The capacitive-bearing (input) button members 104 of the tactile input interface 103, adhering to the teachings of previous inventive discourse, see a tethered coupling by any serviceable conductive medium such as, but not limited to, a flexible wire 105 that capacitively pairs each (input) button member 104 with its respective soft-button counterpart (by virtue of an attachable and serviceable output interface represented by annotation 106, although an attachable interface 106 is not shown attached to a touchscreen in the accompanying figure). Or stated differently for purposes of understanding, with more of a literal emphasis to the two opposing wire tips of a tether, on one end of a wire-tip is a capacitive-bearing button member 104; capable of engagement upon manipulation by the control input of a finger supplying a capacitive charge, and, on the opposing wire end, a corresponding element of an attachable output interface 106. The length of wire 105 servicing the tether faithfully honours a capacitive path between the control input and control output interfaces.

The controller design described in the present embodiment may afford the user with an exceptionally more precise, convenient and empowering way to control an actionable (on-screen) object, while still permitting fluent access to the mounted touchscreen device 101 for finger swiping gestures (if, for instance, it is deemed integral to the game being rendered) and/or fluent user influence on the integrated sensors of a touchscreen user device, such as, but not limited to, the gyroscope, accelerometer, proximity, GPS (Location Services measuring positioning) or digital compass, etceteras, where available and/or where integral to the engaged gaming dynamics. A tactile-input interface 103 may also be placed on the borders adjacent to the touchscreen of a touchscreen user device 101 (with any serviceable conductive medium serving in respective tether to the soft-button members of a soft-button controller); without use of a suspension device, as indicated in FIG. 1A.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. In accordance with an embodiment, an attachment interface is befittingly superimposed over a soft-button interface; such that each button member 104 is communicably assigned, by any means serviceable, to a respective soft-button for purposes of controlling an actionable object or object plurality (remotely from the touchscreen), in the spirit and scope of this discourse. As previously suggested, the tactile-input interface 103 of a handle member may, of course, also be designed for wireless control of an actionable object or object plurality without having an attachable interface (an interface being reliant on a quantity of capacitive charge being transferred from the control input of a finger) being introduced to a controller environment.

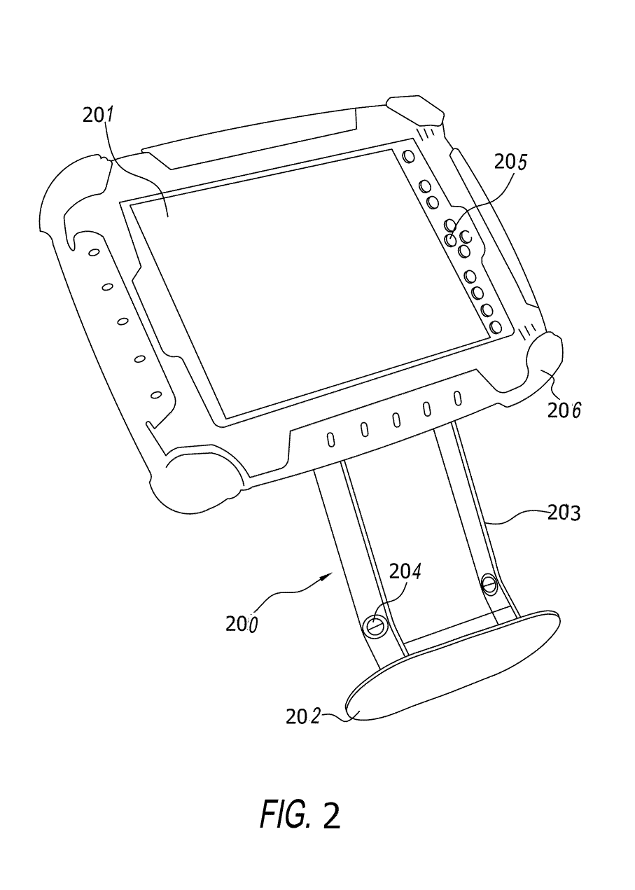

According to an embodiment, FIG. 2 primarily distinguishes itself from FIG. 1 in that the grippable-handle members of the suspension device 206 are replaced by a ready-mount 200 underpinning that firmly supports the touchscreen device 201 positionally, such that fluent touchscreen access by a user's hands is permitted. As a user's hands would be otherwise or traditionally occupied by the concurrent grasping of a touchscreen device 201 during use; this embodiment serves to appreciably liberate them. Examples of a ready-mount 200 system may include a user-mounted mechanism—for instance, an anchor mechanism 202 permitting secure attachment to a buckle clip or belt's lining—or a lap-mounted variant designed to sit snugly on the lap of user during engagement of a touchscreen device 201, however, as this is mere exemplary discourse, it in no way is intended to suggest limitation.

Expanding further on a buckle-clip system in illustrative fodder, the ready-mount 200 system may comprise a rigid, yet adjustable suspension arm 203—one that, for instance, may see the suspension device's receptacle for a touchscreen user device 201 hinged on a sliding omni-directional “ball-joint” swivel (not the subject of illustration) at its underside; sitting encased in flexible rubber and fluently permitting the functional influence of a user's hand gestures on such input sensors as a gyroscope by, for instance, allowing an angular and traversing influence on the suspension device, and by association, the touchscreen device 201. Left-and-right, top-and-bottom tilting, a degree range of traversal freedom; as a case in point, are readily permitted by the ball-joint mechanism. The omni-directional “ball-joint” swivel assembly may see rubberized design tweaks present that permit for movement fluency by a hand influence and will return to a position of rest automatically upon release by a user's hands. The adjustable suspension arm 203 may contain a lockable-pivot mechanism 204 (that uses a threaded screw to lock a device securely upon selected positioning), if so designed, for secured positioning versatility.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. A capacitive-bearing button member 205 or member plurality may be communicably linked—by any means serviceable to the spirit and scope of the inventor's established discourse—to a/the respective soft-button member or member plurality of a soft-button controller. An attachable discharge overlay and/or an associative wire and/or wireless tether capably serve as embodying fodder of the present invention.

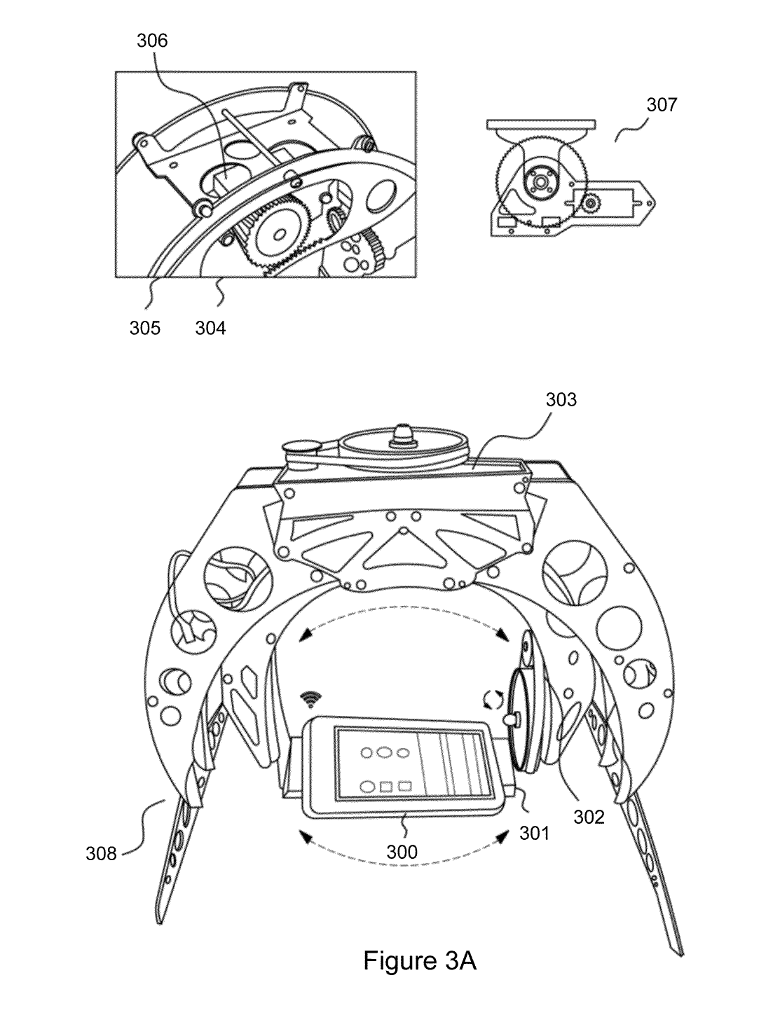

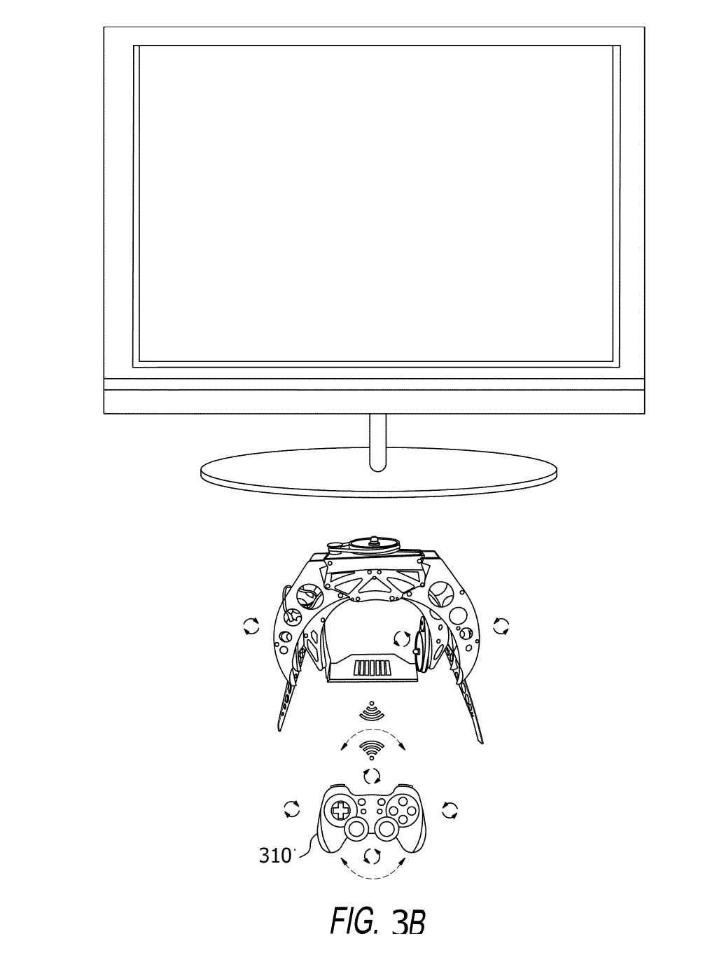

According to an embodiment, FIG. 3A represents a mounting apparatus 308—a host device equipped with an influenceable platform 301 that may be subject to bidirectional or omnidirectional movement; with said influenceable platform 301 unto which a viewable touchscreen device 300 sits securely affixed—comprising, at least according to this exemplary discourse, a type of support structure where 2-axis gimbals reside. Whereas a servo plurality (guided by a microcontroller) is respectively enlisted to provide for controlled movement (based on variables such as positioning, tracking and a target determination) to each axis. A servo motor in preamble, is, of course, a small electric motor that spins an associated gear when a servo is connected to an electrical current. (see FIG. 3A, 307) The gear, in turn, drives other devices such as, but not limited to, a wheel assembly. According to this embodiment, the electrical current may be provided by a voltage source or a current source

The viewable touchscreen device 300 may be mounted on a bi-directional platform 301, without suggestion of axis or related limitation, and subjected to the influence of, for instance, both a front-and-back servomechanism 302 and left-and-right servomechanism (see 304, 305, 306 of a serviceable left-and-right gear design associated with a primary mounting apparatus 308) and their associated gimbals.

For added directional versatility of a mounted touchscreen device 300 beyond that which is bi-directional, an additional servo motor and axis gimbal may be enlisted, if so inclined in a controller environment. For purposes of not unduly burdening the description beyond bi-directional disposition, however, a left-and-right servomechanism (see 304, 305, 306) may be replaced with a panning servomechanism 303 that is mechanically designed to spin or revolve the linked platform 301 in a 360-degree range of motion—in both directions—by means of having the respective gimbal mounted on a corresponding servo axis. A microcontroller calculates an input controller's (FIG. 3B, 310) angulation directives as they are broadcast, whereas these calculated directives are then instantly and faithfully relayed to the respective servo or server plurality in order to match or duplicate the angular adjustments (an input controller's 310 angulation directives or gestures), under servomechanism influence, to the bidirectional platform 301 of a mounting apparatus 308, and hence, the mounted viewable touchscreen 300 associated to it. The mapping of angular motion is done, in the spirit and scope of this discourse, in order to influence such gaming dynamics as, but not limited to, a gyroscope sensor, remotely.

The bidirectional movement of a 2-axis gimbal, as suggested above, is designed to faithfully mimic, for instance, an angular reflex first produced by a remote input-controller (FIG. 3B, 310) influence, e.g. an articulated gesture, under the care and operation of a user and then communicably disseminated to each enlisted servo for positional assignment, as managed by a microcontroller assembly or controller assembly. Assuming the potential servo and gear-assembly depicted by arrangement 304, in an effort to facilitate reader understanding, as a user leftwardly (in reference to a left-handle metric) tilts the input controller (FIG. 3B, 310) in a downwardly-sloping angle; a respective servo motor 306 is engaged, thus driving a gear assembly (comprising a serviceable gear ratio permitting a fluent and timely translation of a controller gesture) that results in the left-and-right suspension arm 305, influencing a viewable touchscreen device 300 by associative armature connection, traversing in a counterclockwise or “leftward” motion. Although not illustrated in arrangement 304, a similar servo structure may be present in the mounting apparatus 302 to mechanically position for the reflex action of an input controller (FIG. 3B, 310) that is rocked or gestured from front-to-back in order to manipulate orientation of a touchscreen device 300 by jockeying its front-and-back end, respectively.

A similarly-purposed iteration may include a mounting apparatus 308 with a plurality of servos capable of subjecting a viewable touchscreen device 300 to omnidirectional movement, including both horizontal and vertical traversing at its base. As suggested, a mounting apparatus 308 or apparatus plurality may also include a 3-axis arrangement (although not requisite and not specifically-addressed in the figure) whereas a third servo may be added that employs a shaft that is serviceably attached to, for example, the front-to-back servomechanism 302 allowing the coupled servomechanism to spin in a 360-degree motion. A microcontroller assembly may be programmed for the consideration of each servo. The input controller (FIG. 3B, 310) may be further synced with a viewable touchscreen user device 300 to enable remote operation of an assigned soft-button controller or controller plurality, wirelessly, or conversely, it may assume a variant design of soft-button actuation by virtue of integration of an intermediary-transceiver device with an attachable interface into the servo armature. The input controller (FIG. 3B, 310) may comprise its own electronic sensors, including, but not limited to: proximity, accelerometer and device-positioning sensors, including use of a gyroscope for directive relay by an integrated circuit to the associated microcontroller assembly of the primary mounting apparatus 308; which then manages actuation of the corresponding servo motors, as necessary to the “reflex” response, and thus, reaches the viewable touchscreen device 300 at its routed end to reflect proper gesture “mimicking”.

Further, the incorporation of direct-drive motors and accurate encoders for superb responsiveness and pointing accuracy are also serviceable to this discourse. The direct-drive motors, powering a plurality of gimbals, may be structurally coupled to respective encoders and a counterweight system. Under this system: gears, flexible couplings, timing belts and virtually all conventional sources potentially attributed to positioning error, in a mechanical-drive system, are absent. Under this system, rotational “reflex” may occur more rapidly, without the need for the manipulation of gear ratios. High precision, angular contact bearings—yielding minimum friction and zero-bearing clearance—may further be strategically implemented in a controller system to add exclamation to the accuracy of, and to the user experience associated with, a controller device for touchscreens.

Brushless linear-direct drive servomotors, as well as ball-screw iterations driven by either brush or brushless rotary motors, may also be suitably adapted for achieving the desired purpose of remote angular mimicking of a touchscreen user device and further serve to illustrate the breadth of serviceability to this embodiment. A rail system and series of gears could, in further exemplary discourse, readily be assimilated to accomplish gimbal-based servo travel of +/−90 degrees and rotation of the inner gimbal ring by +/−55 degrees, for instance, with serviceable reflex speeds (under a pitch mechanism directly driven from a servo). The servo motors may be governed by a servo processor or sequencer comprising the controller interface and may be powered by a voltage source or a current source. An associated potentiometer may be controlled by the servo processor and, like other exemplary discourse, is based on the input gestures of an input controller (FIG. 3B, 310) that is wirelessly paired with the servo interface for the purpose of communicating directives or gesture relay. Ball/socket armature comprising threaded or non-threaded rods and stepper motor integration with standard RC servo mounts may also be readily configured by those skilled in the art to achieve the intended and common purpose, as the embodiment in point, of angular mimicking. Such multi-rotor frames may be fitted with a controller board that manages the servo outputs and the respective gimbal assignments. The multi-rotor frames, including any related components such as the armature, along with the positioning of servos, may vary widely from this figure while still assuming the spirit and scope of this discourse.

Any method serviceable to the spirit and scope of this discourse, including, but not limited to, any structural arrangement of a positioning mechanism or mechanism plurality permitting faithful orientation (such as, that being capably inclined for movement in all directions) in response to the influence of an associative torque and/or a similar ascendency, is embodiment fodder. An intensely tweaked and tested gyroscopic mechanism, as constructed and manipulated by the inventor in a touchscreen environment, has contributed to the accompanying discourse. A divergent gyroscopic mechanism operating under a piston assembly, was also tested. Collectively, all servo motors and/or any serviceable positioning mechanisms falling under the scope of embodying matter herein, are primarily designed, in accordance to this exemplary discourse, for remote and ground-breaking influence of, or interaction with, a touchscreen user device and any of its responsive controller apparatus, such as, but not limited to, the accelerometer and/or positioning sensors such as proximity, gyroscope and those device-based.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. Integration of an intermediary-transceiver device with attachable interface (not the subject of illustration) into the servo armature may occur for assistive control of an actionable on-screen object or object plurality, in the spirit and scope of this discourse, where coveted.

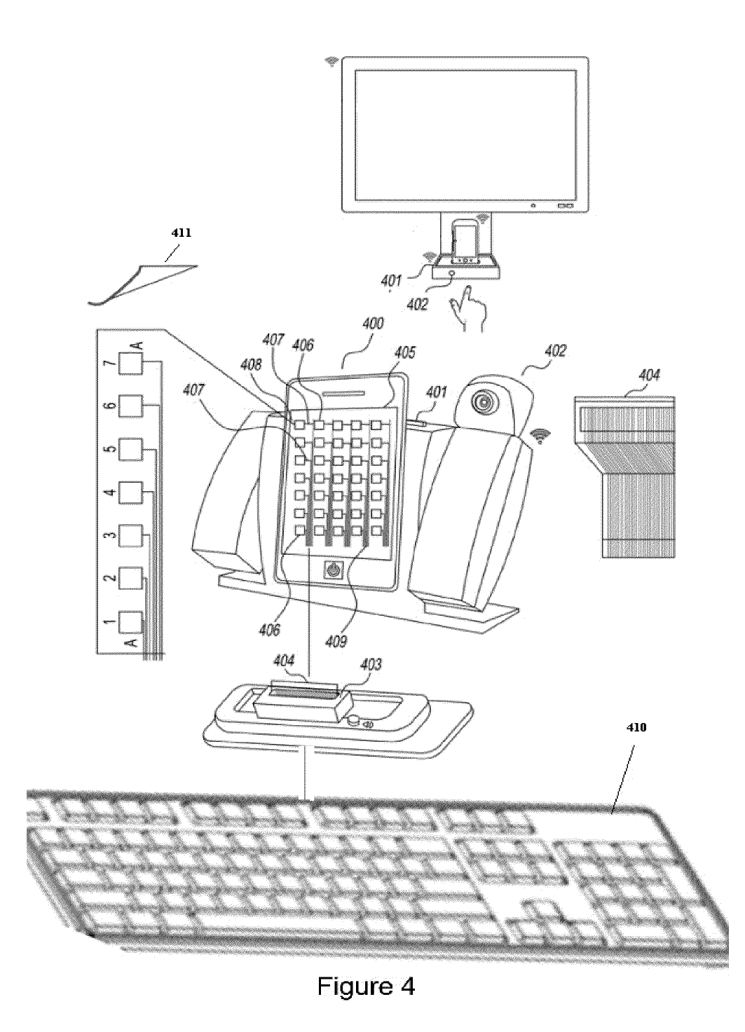

According to an embodiment, FIG. 4 illustrates a method and assembly of strategically deploying a capacitive charge or charge series to the receptive touchscreen of a touchscreen user device 408, based on an input metric provisioned by a trackable gesture. And while not the central focus of this embodiment, the deployment of a capacitive charge using an overlay assembly may also be incorporated into a keyboard 410 and/or keypad environment without the use of an intermediary device with camera where the user becomes the power source (a capacitive power source) of the input device in leveraging conductive keys comprising serviceable conductive paths (for related discussion of such a green controller please see FIGS. 12, 13 and 14 of U.S. Pat. No. 8,368,662). The inset illustration comprises an exemplary intermediary device built into a HDTV touchscreen device.

A touchscreen docking-station 400 comprising an intermediary-transceiver device 401, a tracking camera 402 (capable of ascertaining input gestures for productive capacitive output), a junction socket with base 403 (responsible for furnishing a capacitive supply) and connecting ribbon 404 are shown. The method and assembly of the present embodiment permit for the productive tracking of a user gesture (an input) or gesture plurality for the intended purpose of translating said trackable-gesture or gesture plurality to an associated point or domain of the touchscreen on a touchscreen user device 408 (via a modal output, faithfully, in espousing the managed ability for capacitive discharge), just as if a user directly engaged a touchscreen user device 408 with the control input of a finger. In serviceably tracking an input, without suggestion of limitation, a software app could be created that, once launched, syncs an on-screen pointer (rendering a continuance of orientation, facilitating such) with a tracking camera 402—innate to the user device, paired intermediary-transceiver device 401 or both—that is capable of tracking a user motion, such as a finger-driven input. A library of gestures could be recognized beyond the simple “drag” feature that can be easily ascertained, for instance, by a user dragging his or her finger in a particular direction. Furthermore, the torso of the user could be used as the configured backdrop for “framing” the touchscreen by a tracking camera 402 for the mapped input-orientation of a finger.

A thin, transparent overlay 405 sees initial application of an independent tiling of transparent Indium-tin oxide coatings 406 on both its face and rear surface (to ensure a means of conductivity is present throughout the overlay in the areas treated/coated with the ITO only and not in the area adjacent to the ITO treatment, especially in reference to the structured process of overlay layering) in an arrangement that equally departmentalizes (an assembly of equal parts or “tiles” comprising the tiling, with emphasis on the borders existing between the patterned transparent Indium-tin oxide coatings 406 or tile distributions; the borders serving as an insulated environment) the overlay for fluent touchscreen assimilation across all salient screen domain. The initial tiled pattern of transparent Indium-tin oxide coatings 406 is consistent and predictable, with a separate, communicable subset of ITO conductive coatings 407 later applied to each tile of the initial application of transparent Indium-tin oxide coatings 406. The separate, communicable subset of ITO conductive coatings 407 are applied to the upper surface of the overlay only (that is, so each transmission line is not capable of unintended transmission, along the span of a conductive path, to the touchscreen user device's 408 touchscreen surface residing just below the bottom of the thin, transparent overlay 405 upon attachment and, hence, only serves as a connective conduit to the contact points of the governing capacitive discharge system of an intermediary-transceiver device 401.

The intermediary-transceiver device 401 may supply, manage and/or deploy a capacitive charge based on the input metrics received, fluently, and, under the described method and assembly, is capable of honouring a conductive path from the point of origin of the specific tile of transparent Indium-tin oxide coating 406 seeking engagement and up to and including an exit point at the bottom of the overlay that seeks attachment to the respective contact point of a capacitive discharge element or junction socket 403 of an embedded intermediary-transceiver device 401. The highly-transparent coating strategy may provide (please note that the dark squares and conduit lines or channels representing the Indium-tin oxide coatings 406 and separate, communicable subset of ITO conductive coatings 407, respectively, are for illustrative purposes only and such application of an Indium-tin oxide coating will remain highly transparent in nature in production runs) for virtually indistinguishable transparency upon application and touchscreen illumination, yet still affords the user comprehensive control functionality of the salient screen domain of a touchscreen user device 408, remotely, under the described method and assembly.

In this exemplary discourse, a thin, transparent overlay 405 is individually layered (with the layering process, again, producing a finished overlay that is virtually unnoticeable when in place during touchscreen illumination; thus permitting highly vibrant broadcast definition) with respective Indium-tin oxide coatings 406 that are both produced and layered in verbatim arrangements to its layered peers, in accordance with this exemplary discourse. Upon layering arrangements, with repeated emphasis, care is made to ensure the upper surface of an overlay remains wholly insulated and not capable of incidentally transmitting a capacitive charge to the surface of a touchscreen during the act of conductive channelling presented by the separate, communicable subset of ITO conductive coatings 407 applied to the upper surface of the layered transparent overlay 405. The arrangement of said communicable subset of ITO conductive coatings 407 on the upper surface only forces deployment of a capacitive charge to occur only at an addressed point of contact on the touchscreen of the touchscreen user device 408. Indium-tin oxide coatings 406 may assume, for instance, a size proximal to the width of a finger tip or the size of a soft-icon or the icon of an app to which the thin, transparent overlay 405 is capable of engaging remotely; based on the spirit and scope of this discourse.

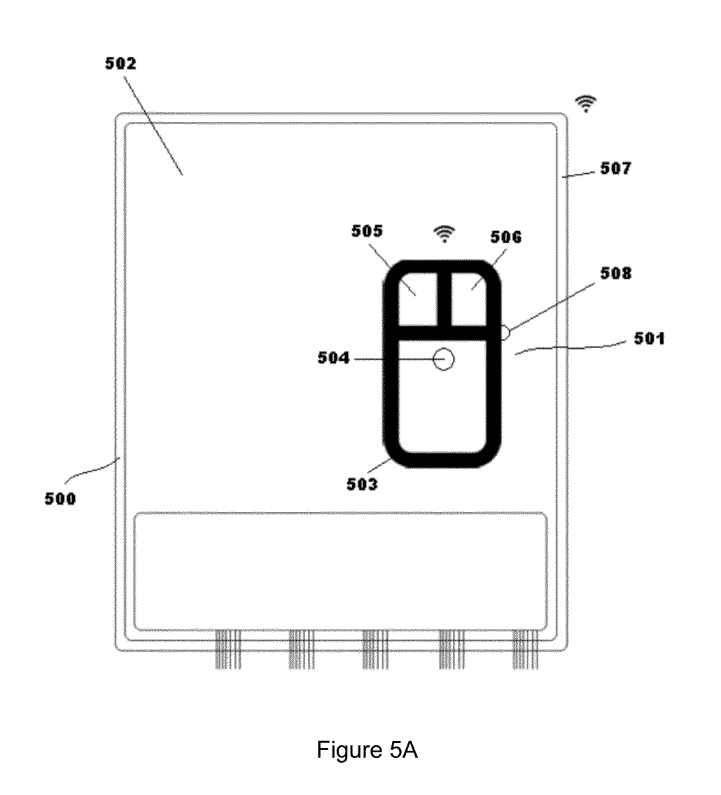

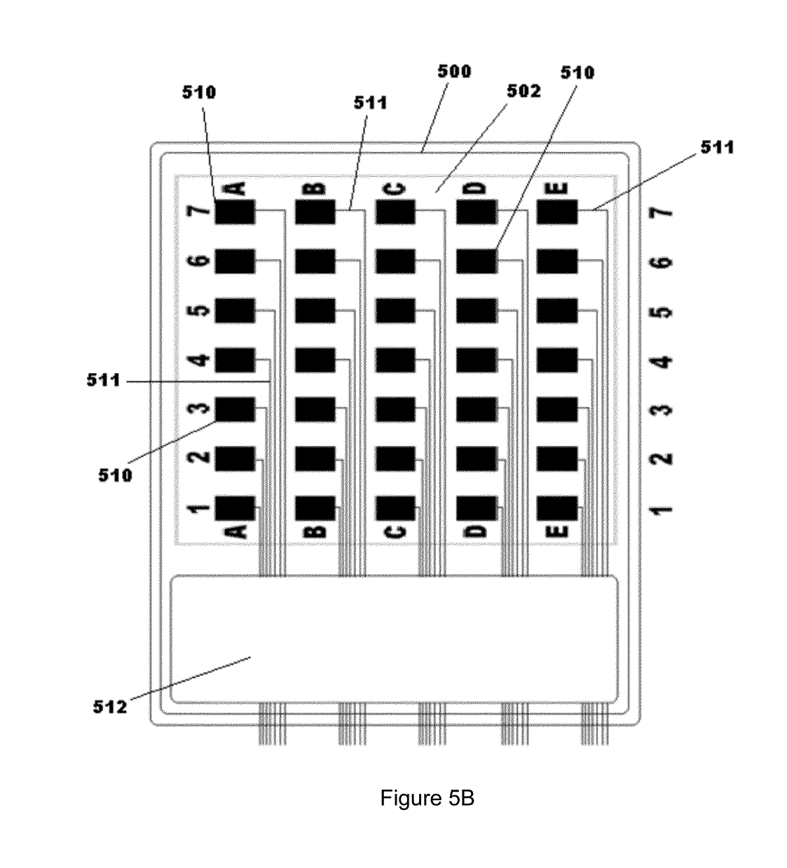

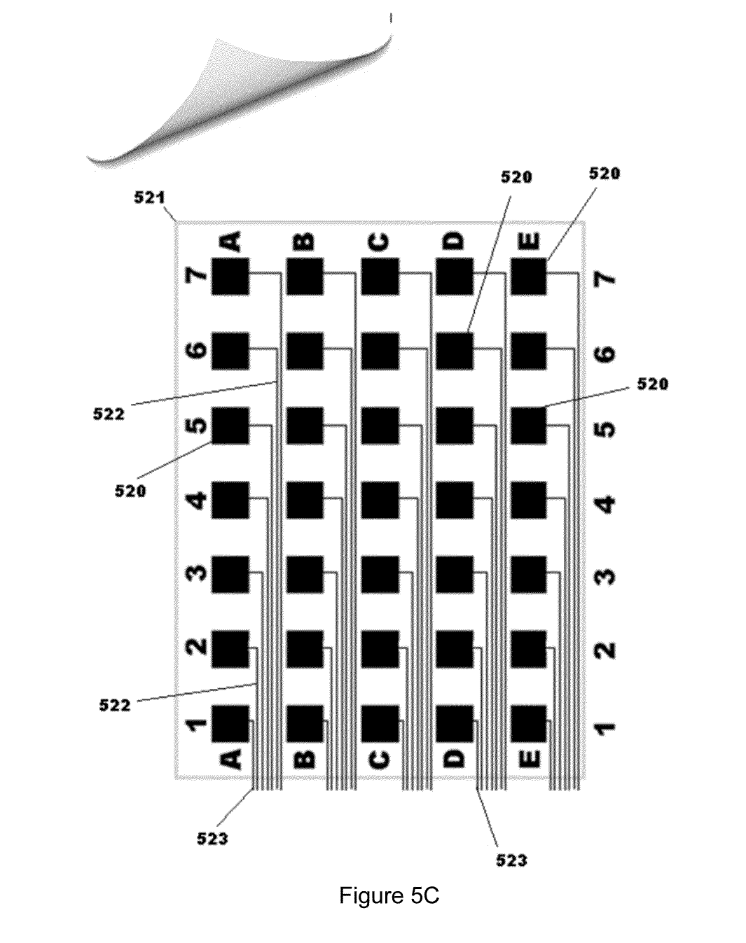

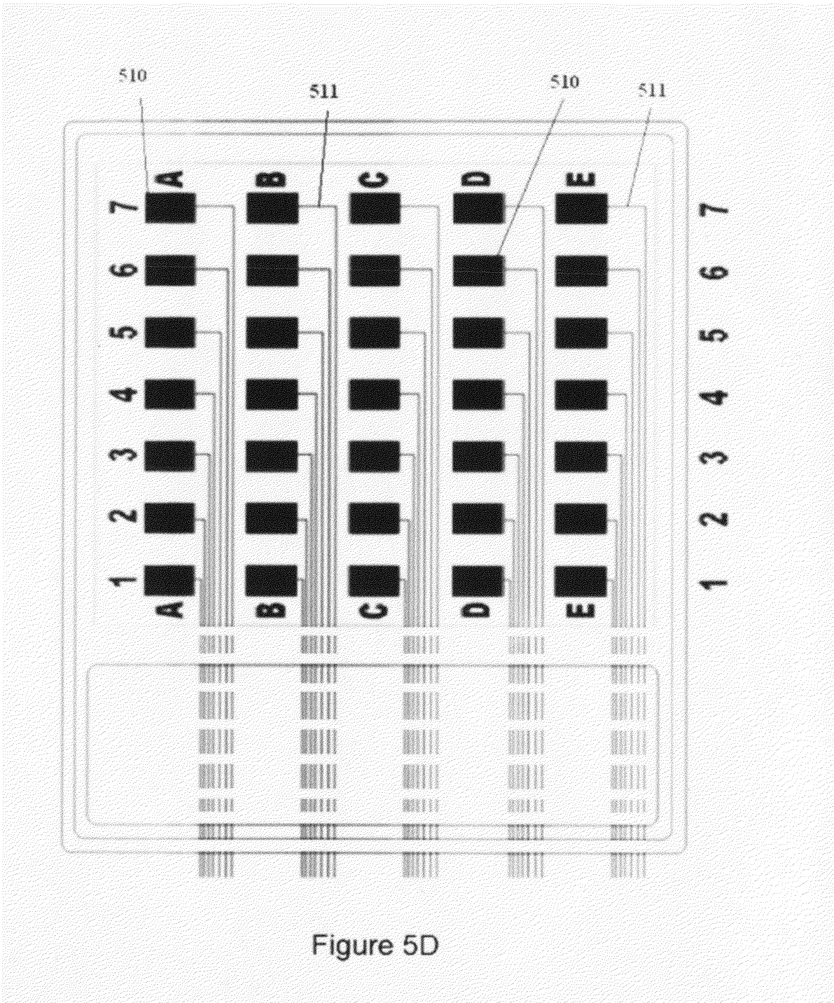

The thin, transparent overlay 405 is removably attachable to the touchscreen of the touchscreen user device 408 by any serviceable means, such as, but not limited to, a residue-free adhesive coating that may detach itself from a touchscreen as it is peeled 411 away. The exit points 409 of the thin, transparent overlay 405 (the overlay serving as a capacitive output) are respectively connected or tethered to the contact points of the capacitive discharge element or junction socket 403 of an intermediary-transceiver device 401, by a connecting ribbon 404 or any means serviceable, for faithful transmission in a manner that concatenates all coveted conductive paths in the spirit and scope of this discourse. The act of “concatenating” and its literal intent is readily understood by those familiar with the inventor's prior teachings in accordance with the previously-filed applications cited above and will be elaborated on further in FIGS. 5A, primarily, with an alpha-numeric based delineation system, and 10, amongst others, when referencing a transparent overlay. Of course, the teachings of the present embodiment, all embodiments within the spirit and scope of this discourse, may be allied with other embodiments taught in this paper, where it is serviceable to do so, and, furthermore, may be allied to the embodying matter of all other applications previously submitted by the inventor, where it may be serviceable to do so.

Intending to suggest breadth in scope in the task of strategically deploying a capacitive charge based on the input of a trackable gesture, a capacitance-bearing plotter device (not illustrated) is further discoursed in an additional embodiment. The capacitance-bearing plotter device is also capable of mapping a hand gesture to capacitive delivery on a targeted locale of a touchscreen and remains serviceable in variance to the above noted embodiment of FIG. 4. According to this iteration, a capacitance-bearing plotter device is directionally governed or influenced by a user's motions (particularly the hands, without suggestion of limitation); with said motion input delineated by an associative camera—and any associative tracking software—innate to an intermediary-transceiver device, the touchscreen device or both. The capacitance-bearing plotter device comprises an intermediary-transceiver device that is capable of supplying and managing an innate capacitive load for targeted discharge to the surface domain of an engaged touchscreen.

As a user's motions are capably tracked, a plotter head with capacitive relay (or head plurality when more than one plotter head is concurrently associated to a touchscreen) is integral to the modal capacitive output. The capacitive relay at the tip of the plotter head is pressed against a touchscreen upon engagement and is designed to directionally mirror a user's movements (action is in direct response to a user's movement) within the preset parameters of a touchscreen's dimensions; providing care not to breach the display area. The plotter head's capacitive relay is made from a non-abrasive, glass safe and conductive material and is capable of intermittently supplying a capacitive discharge based on a prescribed user gesture or remain “always on” such as required when a finger is being swiped across a touchscreen with a continued supply of capacitance. In this way, a user directs the capacitive relay, remotely by gesturing to a camera, across the screen to a coveted location. For instance, a capacitive relay (a “pointer”) may be motioned over an app that the user intends to launch and then may activate said app by either supplying a capacitive load directly or by first disengaging any active capacitive supply to the capacitive relay that may be present during a “finger-swipe” motion, then re-engaging a capacitive load thereafter. The capacitive relay and any member of the capacitance-bearing plotter device directly engaged within a touchscreen's (surface) viewing area is preferably transparent in nature where possible, to provide for more fluent user viewing.

The capacitance-bearing plotter device may be governed by a two-axis control system; with each axis remaining independently driven by a mechanical system such as an associated stepper-motor and channelling-belt assembly. A capacitive relay mechanism is specially designed to apply and disengage a traversing supply node, as coveted. The control of the capacitance-bearing plotter device may be achieved using a servo mechanism comprising a plurality of servo motors under the governance of a servo processor and may be powered by a voltage source or a current source. The rotary motions ascribed to both the stepper-motor's shafts (representing an X and Y axis) are, of course, intended to translate to touchscreen-centric linear motions under control of the servo processor (a microcontroller) and its related electronics. Linear motion occurs across the sliding X and Y motion translation arms; rigidly constructed and least-intrusively mounted. When referencing “least-intrusively mounted” in any exemplary discourse, the design parameters may revolve around maximum viewability at its impetus, such as with the use of transparent material, including the elements involved in capacitive discharge. The X-based stepper motor moves the plotter head along the X axis in a left and right manner, while the Y-based motor moves the plotter head up and down along the Y axis; thus affording expansive touchscreen coverage as per the embodiment discourse. A sliding component consisting of two bearings and a plotter head, for example, may resolve the simultaneous motions of the X and Y axis' and serve to drive the plotter head with a-marginal degree of displacement error in order to track a user's gestures for intended actuation onto the touchscreen surface of touchscreen user device. A third stepper motor (Z-axis), also under the control of a microcontroller, may further be enlisted to lift and reapply the plotter head to the touchscreen's surface, as coveted, remotely.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. See attachable thin, transparent overlay 405. In addendum: wireless operating scenarios under the governance of an intermediary-transceiver device 401 (where an intermediary-transceiver device 401 directly transmits broadcast directives to a touchscreen user device 408 without the need of an attachable interface being assigned) may be further embodying fodder of the present invention.

FIGS. 5A-D illustrate a mouse-input device—traditionally associated with a desktop environment—as transitioned to a touchscreen environment by the inventor, under a described method and assembly. Due to potential limitations of a touchscreen's traditional input protocol, further operating conditions may arise where a user may find marked benefit in transitioning away from the modal input of direct finger-to-screen contact on a touchscreen user device to a facilitative hardware device that, amongst other benefits, can make modal input emphatically more intuitive and convenient. Such may be the case where, for instance, a user chooses to control a desktop environment by using a native touchscreen device as the controller. Or more specifically, as a “digital-mouse” controller. Under the traditional soft-button layout and touch requirements that may be required to operate the desktop, remotely, using the native glass interface as the exclusive input medium—a user may find this process unnatural or tedious at best when, for example, performing a course of repetitive tasks. Task “fatigue” may be especially apparent when this experience is filtered in direct contrast to the familiar convenience of using a conventional mouse-input device on a desktop environment. The inventor seeks to address this attenuated experience by creating a mouse-input device for touchscreens, borrowing heavily from the typical operational protocol (for instance, affording the user familiar left-and-right mouse button functionality) associated with its desktop brethren.

According to an embodiment, both a mousepad 500 (FIG. 5A) and mouse 501 (FIG. 5A) are transitionally introduced to a touchscreen environment. The mousepad 500 sees its “drag” surface 502 constructed from a thin, serviceable conductive skin 502 housing a plurality of conductive actuators 510 (FIG. 5B)-comprehensively arranged in a neat, uniform pattern—immediately below the conductive skin's 502 surface. The conductive actuators 510 remain in conductive contact with the conductive skin's 502 surface, thus maintaining the conductive path necessary in the spirit and scope of this discourse. Each of the conductive actuators 510 (responsible for registering a control input or modal input) of the mousepad 500 sees an independent delineation or conductive channelling 511 occur to an exit point, thereat conjoined by tether to a respective conductive actuator counterpart (at the opposing end of the tether)—by virtue of, for instance, without suggestion of limitation, a wire—thus, conjugating a conductive tether (from the end of capacitive input to the end of capacitive discharge) upon this linked conclusion. Said differently, each independent tether, from its point-of-origin on a controller input (conductive actuator 510 in the plurality), travels to a corresponding origin on the (remote) set of transparent Indium-tin oxide coatings 520 (FIG. 5C) present on the thin, transparent overlay 521 (FIG. 5C), serving as a controller output since it is responsible for the capacitive discharge, by any means serviceable in tether. The modal output is, of course, situated on the opposing end of a control or modal input by virtue of a conductive tether that honours a conductive path throughout.

As understood by those skilled in the art, a length of tether that honours a conductive path—or a conductive element such as a conductive actuator 510 participating in a conductive path—may be comprised of any electrically-conductive material or combination of conductive materials, including but not limited to, conducting polymers such as polyaniline, conductive gels, conductive liquids, conductive inks, conductive coatings, including those beyond the cited Indium-tin oxide coating, conductive wire, printed circuit board and/or any material that is conductively (exhibiting conductivity) dipped and/or coated—such as with the use of treated foam, thread, or fibers—used alone, in filler compositions or in a series of conductive combinations, as aptly conjoined to ensure a proper conductive path remains present. In honouring this conductive path, fluent and remote operation of a soft-button controller input (remote from the touchscreen itself) is possible under the inventor's teachings. The transparent Indium-tin oxide coatings 520 or “tiles” are also not limited to the use of conductive coatings, and instead are purposed by any means serviceable, as a matrix interface in previous discourse broadly illustrates.

In previous discourse, to elaborate further, the inventor described a nodule or nodule plurality comprising a matrix system as a modal output for control of actionable objects on a touchscreen, which may serve as embodiment fodder for contrasting iterations not illustrated. In such iterations, a modal output may assume a highly-transparent matrix comprising a grid-like formation of individually insulated, conductive nodules—proximately sized to measurements slightly beyond the span of a finger tip—that capably interact with an encompassing quantum of touchscreen surface area upon attachment. Each conductive nodule may, for example, be filled with a conductive liquid, such as water to facilitate transparency, and have a thickness diameter that slightly extends the exterior surface of the matrix beyond the touchscreen's surface and thus, allows for isolated/insulated conductive tethers to occur via the leveraging of border conduits of the matrix that are not in direct contact (capable of a capacitive discharge) with the touchscreen. Each nodule comprises an independent conductive path as they are being channelled or extended, with all nodules, in their entirety, providing for a comprehensive screen mapping upon placement. Each individual nodule's tether can be made serviceable by integration of a conductive medium such as, but not limited to, the communicable application of a durable and insulated conductive coating on the matrix's underside (for example, each coating's “print” line runs independently from each conductive nodule in the column to a conductive integration point or exit point at the bottom of the matrix), the integration of a transparent or a “minimalistic” wiring scheme and/or transparent liquid channelling. For purposes of this illustration, however, references to transparent Indium-tin oxide coatings 520 present on a thin, transparent overlay 521 will serve as the modal output and not the use of a sister matrix attachment.

A tether between a conductive actuator 510 and its wire extension 511 and the respective Indium-tin oxide coating 520 present on the thin, transparent overlay 521 can be conjoined using a conductive pairing device or connector (not shown) such as, but not limited to, a copper-based connector facilitating both interfaces. Integration points could be facilitated further by a method of colour coding present on the connector face. Expanding further, each transparent Indium-tin oxide coating 520 or tile present on a thin, transparent overlay 521 is accompanied by an independently run conductive line 522 that exits 523 at the bottom of the thin, transparent overlay 521 in a pattern and spirit that may borrow from FIG. 4. It is at this point of exit 523 on a thin, transparent overlay 521 (a modal output) that a conductive connector may be integrated to accept and conductively pair a respective wire extension 511 (associated with the corresponding conductive actuator 510 originating at the mousepad, a modal input) with the associated conductive line 522 coated, etched and/or printed on the thin, transparent overlay 521, and so on, until each conductive actuator 510 and Indium-tin oxide coating 520 is accounted for by virtue of capacitive pairing, in the spirit and scope of this discourse. The bottom of the thin, transparent overlay 521 may extend beyond the touchscreen face for non-intrusive connector integration. Furthermore, a specially designed dock or cradle, for instance, may provide fluent access to the connector along with its conductive integration points by means of, for instance, an integrative socket accepting both the input and output interface. Beyond expeditious tether assembly, the specially designed dock or cradle may help facilitate an environment of minimalistic clutter; helping foster a tidy appearance in regards to conductive pairing associated with the mouse assembly. Since the concealed wire tethering occurs from the conductive actuator 510 plurality in a stationary mousepad 500 and not from the actual mouse 501 itself, according to an embodiment, the mouse remains wholly unencumbered or “wireless”; thus, permitting for fluent drag and drop and traversing motion, amongst other benefits.

The mouse 501 structure comprises a conductive shell, thus permitting a capacitive charge present in the hand (grasping the mouse 501 device) to be transferred to the conductive actuators 510 upon engagement, in a pattern “faithful” to a “mouse drag” or “finger swipe”, and then completing with a capacitive touchscreen discharge at the element (a transparent Indium-tin oxide coating 520) assigned to a conductive path's conclusion, by virtue of the described tether. The assigned element or 520 of a thin, transparent overlay 521, may coincide with the position of a mouse pointer for a targeted capacitive discharge upon serviceable attachment of a thin, transparent overlay 521 to the touchscreen, with more on this process to follow below. With emphasis, a case in point is made where the thin, transparent overlay 521 supports capacitive transfer in a manner faithful to an omnidirectional “mouse drag” occurring remotely on an associated “mousepad”, made possible through the process of described tethering.

The touchscreen's mouse 501 device may assume the exterior aesthetics (image likeness) of a traditional mouse with, of course, marked distinctions in design necessary to transition itself to the touchscreen environment. For instance, in order to thwart unintentional hand contact with the conductive (input) actuators 510 of the mousepad 500 during drag, drop or other mouse-like functions as a mouse 501 device is concurrently grasped and engaged, the surrounding edge of the mouse 501 device, at its bottom, comprises a comfortable lip 503 (represented in part by the thickness of the outer line) that supports/shields the hand from incidental mousepad 500 contact when an engaged mouse 501 is being held, negotiated and/or similarly engaged. The mouse 501 device is comprised of a conductive material such that, as the device is being held by the user, innate capacitance from the user is transferred to the shell of the mouse 501 device. At the mouse device's 501 bottom is a rounded-disposition tip 504 that is capacitively charged in connection with its attachment to the shell (linkage not the subject of illustration). The rounded-disposition tip 504 sees contact with the mousepad's conductive skin 502 and associated conductive actuators 510 below it. Thus, by nature of the wire tether often cited under this embodiment, as the mouse 501 device is dragged across the mousepad's 500 drag 502 surface, user-borne capacitance is transferred to the touchscreen of a touchscreen-user device by said rounded-disposition tip 504; as a conductive path is engaged to fruition of capacitive discharge. Under the disclosed method and assembly, a productive “finger swipe”, for example, is permitted to engagingly occur on a touchscreen, remotely, under the emulation of a “mouse drag” function described herein.

The way the left-mouse button 505 (for example, a single click, double click) is designed to operate, without suggestion of limitation, is that upon a quick, single depression or click of the left-mouse button 505, the rounded disposition tip 504 is quickly lifted (causing an actuating path to be interrupted) and then returned (causing an actuation path to be reengaged) to the mousepad's surface, thus causing an instance of strategic actuation to occur on the touchscreen at a desired location, for instance, at the position of the mouse pointer. Studying the conductive path more closely, the point-of-contact (an output) associated with the addressed Indium-tin oxide coating 520 of the thin, transparent overlay 521 and, in the reciprocal relationship of an opposing tether end, the conductive actuator 510 (an input) of an actuator plurality immediately below the conductive skin's 502 surface, cause capacitive discharge at the position of the mouse pointer upon engagement.

The right-mouse button 506 action may be achieved by, amongst a breadth of other serviceable methods, providing a conductive right-most border 507—the right-most border 507 (comprising an independent wire paired to a respective touchscreen attachment not shown) is constructed to provide an elevated lip to prevent the mouse 501 from overriding—to the area immediately adjacent to the “drag” surface's 502 rightmost edge, as shown. A small, non-obtrusive, on-demand conductive bumper 508 is constructed on the right edge of the mouse 501 device that only sees its conductivity actionably engaged (a mechanism of “on-demand” connectivity resulting in the initialization of a conductive path to the conductive bumper 508, upon engagement, is not shown amongst the components in order to reduce diagram clutter) when a user concurrently presses the right-mouse button 506 and then engages the conductive bumper 508 by initiating subsequent contact with the conductive right-most border 507. As the right-mouse button 506 is clicked in accordance with the actuation policy described, a conductive tether associated with the conductive right-most border 507 is then engaged and an attachment associated with a “right-click” soft-button on the touchscreen device is actuated accordingly. Of course, under a potential “wired embodiment”, an electrical cable comprising a wire tether or tether plurality may exit from the back of the mouse and see a respective attachment member or interface seek direct attachment to a touchscreen at the tether end, as yet another example of such serviceable functionality as, but not limited to, right-button engagement for touchscreens; in the spirit and scope of this discourse. Construction may be designed around preferences of left-and-right handed users. Although the description herein offers a “green” mouse-input device that is strictly powered by the innate capacitance of a user, this is not suggestive of limitation and the mouse-input device may, for example, seek a wireless pairing with a user device directly without an associated attachment. FIG. 5D illustrates more clearly the pattern of conductive channelling 511 (see FIG. 5B) present under the “drag” surface 502; including delineation under the insulated (when insulated, a capacitive charge of a resting hand or arm does not engage the conductive channelling 511 below it) comfortable-gel pad 512 present (FIG. 5B) on a mousepad 500 assembly, according to an embodiment.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. See attachable thin, transparent overlay 521. The mousepad 500 assembly may also be transitioned to a wireless platform, whereas, for instance, a mousepad 500 may be designed to electronically track the path of a mouse input for broadcast (of the articulated directives) to a touchscreen user device, an intermediary transceiver device with attachment or both.

FIG. 5E illustrates a mouse-type input system that leverages an associated camera (or camera-plurality in related iterations) to track a user's finger or finger plurality and/or a recognized input gesture or gesture plurality—with the user's hand articulations, according to this exemplary discourse, assuming the position of “mouse” pointer. A mouse-type input system is designed for modal integration into a touchscreen environment, this according to an embodiment. In a method of operation, for instance, a finger and gesture-tracking app 545 is designed to launch (and attune with) an associated camera 540 for purposes of capably tracking a user's 541 accredited finger path 542, hand articulations and aggregation of associative gestures. The finger and gesture-tracking app 545 may comprise a distinguished inventory of gestures and finger derivations under its recognition umbrella; with said inventory available to the user for purposes of engaging a mouse pointer 543 on the touchscreen 544 of a touchscreen user device and/or may comprise a feature capable of learning new input commands entered and saved to the software by a user in response to camera-pose prompts or a pose series. The gesture-tracking app 545 may run concurrently with other active software, thus affording real-time and concomitant integration with the software into its rendering environment (by virtue of both the software and CPU based processing of an integrative input such as a tracked finger path 542 and/or recognized set of associative gestures).

For instances of assuming mouse-like behaviour in tune with this embodiment, a mouse pointer 543 may be dragged across the touchscreen 544 to a targeted icon 553 for related actuation via the influence of an integrative input associated with a finger path 542, accredited hand and/or finger articulations and an aggregation of associative gesturing potentially beyond that of hand-based input; for the intended manipulation of a primary software application currently running. Said another way, a user may control a primary software application and/or program—such as one that allows control of a user desktop—by using nothing more than, exempli gratia, an associated finger input performed remotely from the touchscreen 544. Under the watchful lens of an associated camera 540, control-input gestures, such as the tracking and reproduction of right-click and left-click functionality, are readily spirited into a-software program for mapped translation.

Mapping hand/finger articulations and/or accredited gestures for corresponding soft-button actuation remains fluent in accordance with the present embodiment. Accredited finger articulations such as, but not limited to, a user 541 tapping a finger of the left hand downward 546 at a point of mouse pointer 543 orientation (with the left hand potentially representing the left-mouse button in continuance with the theme of desktop control cited previously and the downward motion of an articulated finger input representing an intent of actuation) and, conversely, the tapping of a finger on the right hand downward 547 in similar articulation (representing the right-mouse button) may be readily discernible and integrated into a touchscreen 544 environment by the tracking software associated with the camera 540 of a touchscreen user device 544. Up-and-down motions 548, omnidirectional motions 549, double taps 550, two-finger directional swipes 551 and pinching motion 552 may, for instance, comprise a partial list of recognizable input-driven commands in a given tracking inventory. Tracking markers, such as specially-designed thimbles, could also be added to modal finger input, according to an example set forth, for improved discernment and tracking ability, where, for instance, tracking discernment in a given environment may prove difficult. This operating scenario may, of course, also be transitioned to an embodiment catering to an intermediary-transceiver device with camera (employing the camera of the intermediary-transceiver device only) and attachment interface and/or may be concomitantly applied (employing both the camera of the user or touchscreen device and intermediary-transceiver device concurrently), without suggestion of limitation. Furthermore, the operating scenario may be transitioned away from a mouse-type input system to any input-means serviceable, including, for instance, accredited body mechanics performed in a sports game for the intended manipulation of an actionable soft-button and/or soft-button controller.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. In a modified form of the present embodiment, an intermediary-transceiver device with camera (employing the camera of the intermediary-transceiver device) and attachable interface may be introduced to an operating scenario in a commutative brush stroke of embodying fodder.

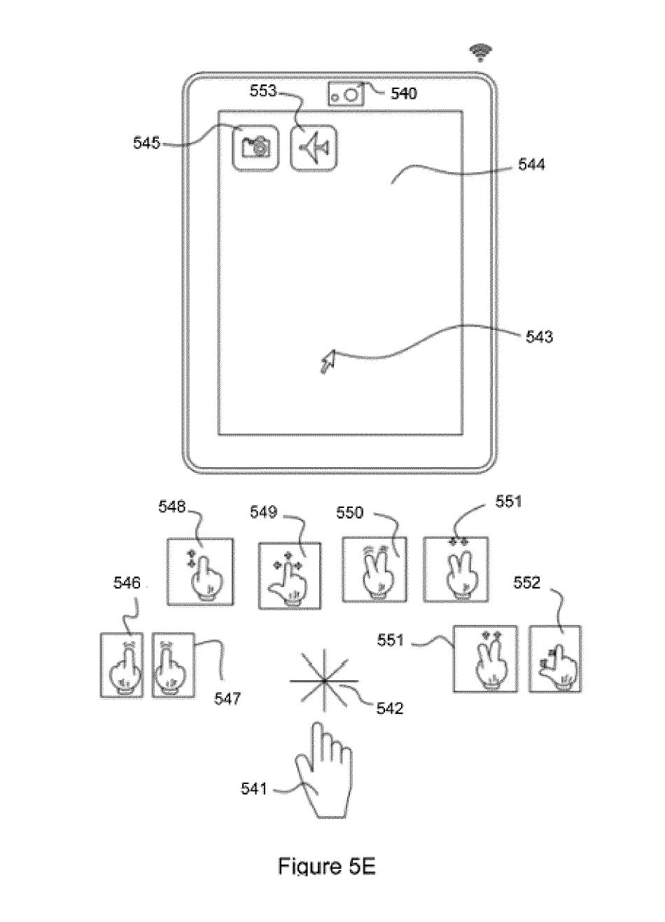

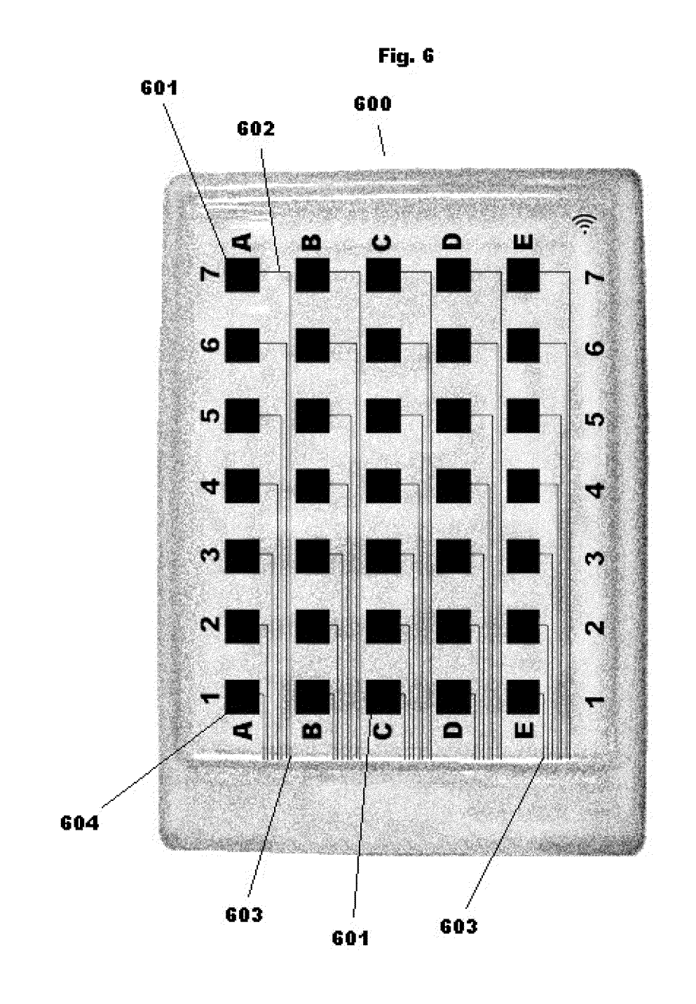

FIG. 6 illustrates a touchpad-input device—traditionally associated with a desktop environment—as it is transitioned to a touchscreen environment, under a described method and assembly. The method and assembly described in FIG. 5B, particularly, with emphasis on the manner in which the conductive actuators 510 of the mousepad 500, residing directly and communicably below a thin, serviceable conductive skin 502 or its “drag” surface, and each actuator's 510 relationship with a respective conductive tether and tether end, is heavily modelled to form the expression of the current embodiment. The kernel of thought being that the embodiment associated with mousepad 500 in FIG. 5B is tweaked, under a common impetus, for the purposeful transition to a touchpad-based embodiment. Perhaps the most notable distinction upon first glance is, whereas a mouse 501 device was designed to strategically facilitate a capacitive-load transfer in the related discourse of FIG. 5B, the touchpad-input device for touchscreens merely seeks the direct control input of a finger or finger plurality on a touchpad for related engagement. While accomplishing the same purpose ascribed to intended actuation, a further distinction is made under this embodiment regarding tethering infrastructure. The conductive actuators of FIG. 5B, assembled in a grid-like pattern, and the manner in which said conductive actuators of FIG. 5B are tethered by connector to their respective Indium-tin oxide coatings 520 (by virtue of a communicable conductive line 522 that exits 523 at the bottom of the thin, transparent overlay 521) for remote traversing of an engaged touchscreen, serve as intellectual fodder for iterating new forms of conductive tethering beyond the most articulated wire interface suggested then, this according to an embodiment.

For this iteration, the conductive (input) actuators 601 of a touchpad device 600 are based on an assigned grid-like pattern etched on a printer circuit board. The assigned grid-like pattern sees each conductive actuator 601, forming the assembly, individually etched—with care to ensure it, along with its conjoined conductive path 602 traversing to an exit point 603, is insulated from competing conductive actuators 601 and their respective conductive paths 602 travelling adjacently—into the formation of a “tile” or square; preferably proximal to the size of the span of a finger-tip and/or a soft-icon associated with, for example, a smartphone device. As suggested above, from each of the individually insulated squares (conductive actuators 601) etched on the printed circuit board, an independent (and respectively insulated) conductive path 602 or channel belonging to an individual square, is annexed by etching a full extension to an exit point 603 located at the bottom of the printed circuit board. The reader notes that components such as 601, 602, 603 indicated by the dark lines are for illustrative purposes only and the printed circuit board, along with its etchings, are communicably housed below the surface of the touchpad device 600 and are not typically visible in the manufactured product, with the potential exception of related coupling arrangements that may, for instance, be incorporated for touchscreen mapping purposes (not illustrated) by virtue of such complementary accessories as an input attachment overlay that may, for instance, serve to compartmentalize a screen domain for purposes of manipulating an on-screen actionable object by capacitive discharge. The exit point 603 will act as a tethering locale.

The reader notes that the shape, size and location of both the conductive actuators 601 and the conductive paths 602 may vary from that suggested in the illustration, while still being faithful to the spirit and scope of this discourse. Each etching, ensuring a serviceable conductive path 602 remains present from “tile” to exit point, is created in respective isolation in order to prevent an incidence of “capacitive bleed” with its neighbouring conductive paths. In one serviceable method, a snugly annexed (from the printed circuit board's exit points, in a relative manner) printed circuit board connector embedded in a rubber skin membrane, strategically supplies a plurality of apertures made for the tethering of a conductive ribbon (a form of ribbon cable, not illustrated) or similar tethering apparatus upon intended connection. The conductive ribbon may extend from the annexed exit points 603 (again, based from the snugly annexed printed circuit board connector upon the intended connection of both serviceable receiving ends) to a thin, transparent overlay (an output interface for capacitive discharge, not under illustration in this embodiment) designed for attachment to a touchscreen.

In a working description for the tether end opposite the conductive actuator 601, the thin, transparent overlay (previously the subject of a detailed discussion) may be manufactured with a network of transparent conductive coatings lining its surface (the network of coatings on an overlay, in their totality, serve as an output medium for relaying a capacitive charge). The network of conductive coatings may be applied in a reciprocal pattern; including conductive-path delineation complete to its exit path, as that etched in the printed circuit board counterpart that comprises a serviceable and communicable pattern of conductive actuators. The thin, transparent overlay may be placed in associative contact and directly above an additional thin, transparent overlay, layer or membrane of equal reproduction to facilitate the premise of layering in the spirit and scope of this discourse.

Expanding further on the premise of layering. A thin, transparent overlay sees duplicate application of an Indium-tin oxide coating on both its face and rear surface in an arrangement that equally departmentalizes the overlay for fluent touchscreen assimilation across all salient screen domain. The dual-sided coating is applied in verbatim application to ensure conductivity throughout the overlay is present in the areas the ITO is coated; thus servicing the advent of overlay layering in the spirit and scope of this discourse. As a thin, transparent overlay is individually layered to facilitate alignment with the respective Indium-tin oxide coatings of its layered peers, integral to the completed network of elements designed to target actuation of a capacitive discharge, care is made to ensure the application of the network of conductive paths (applied to the upper layer only) remains wholly insulated from transmission to a touchscreen surface by virtue of the layered peers below it. Such an assembly is purposefully realized in order to ensure an incidental conductive path is not transmitted to the touchscreen during the act of conductive channelling. The application and strategic arrangement of a separate, communicable subset of ITO conductive coatings (the network of conductive paths, the reader may refer to FIGS. 4, 5A and 10, amongst others, for related discourse) on the upper surface only, based on the spirit and scope of this discourse, forces deployment of a capacitive charge to occur only at an addressed point of contact on the touchscreen of the touchscreen user device by virtue of the tether and associated input directive. That is, the overlay design permits the honouring of a conductive path, fluently, from the ITO (the “square tile” in previous illustrations, for understanding purposes) origin up to and including an exit point at the bottom of the thin, transparent overlay, affording the user robust control functionality from a position of convenience remote to the touchscreen.

Indium-tin oxide coatings of an output interface may assume, for example, a size proximal to the size of a soft-icon or the icon of an app to which the thin, transparent overlay is capable of engaging, from a remote influence, upon touchscreen attachment. The highly transparent indium-tin oxide coatings, as suggested, seek to be actionable with a comprehensive quantum of the touchscreen's surface area upon touchscreen attachment and engageable by a modal input. Although the thin, transparent overlay's highly transparent nature provides for virtually indistinguishable attachment characteristics (including its tether network comprised of a series of transparent coatings) upon illumination of a touchscreen, the user may still opt for use of a Component and/or Composite AV cable or Digital AV adaptor, such as an HDMI AV cable, without suggestion of limitation, as a means of live output from the touchscreen device (source) to an output device, usually an HDTV.

The manner in which exits paths of both the conductive actuators 601 (the input) and the strategically mapped—to mirror an input tile—and channelled conductive paths of the network of transparent indium-tin oxide coatings (the output) of a thin, transparent overlay are serviceably coupled (that is, conductively integrated) are by any means serviceable. To facilitate understanding, this simply means a capacitive charge engaged at the touch input point or coordinates (A, 1) 604, as annotated in FIG. 6, is transmitted or relayed, by any means serviceable in a conductive tether, to mirrored coordinates (A, 1) of a thin, transparent overlay (not under illustration) for purposes of faithfully relaying a capacitive charge to an intended or mapped point on a touchscreen surface upon overlay attachment (the overlay may precisely frame the touchscreen according to an embodiment, although sizing may be proximate without the loss of ability for comprehensive control). The transparent indium-tin oxide coatings in their network entirety (both the assigned channelling and the associated “tiling” responsible for capacitive discharge) are requisite in honouring a conductive path from an exit point to a point of strategic capacitive discharge or the targeted capacitive output exacted on the touchscreen. According to this exemplary discourse, the conductive integration or pairing between the exits points of an input and output interface may broadly be accomplished by means of an annexed connector or a serviceable “connective port” purveyed by an accompanying dock or cradle system for a polished appearance and added mobility.

As a case in point, the exit points of the thin, transparent overlay (an output medium) and conductive actuators (an input medium) may be tethered by a dual-sided (female-to-female) connective port that readily accepts capacitive-bridging strips from each medium in a manner that concatenates all coveted conductive paths, in the spirit and scope of this discourse. The thin, transparent overlays, along with the matching connective port, may be manufactured in a variety of sizes and dimensions to ensure suitable compatibility across all popular touchscreen offerings. A connective port may be designed of a soft-rubber framing structure that encases the conductive bridging material, as to help facilitate a scratch-free application. A separate, thin, transparent overlay (capable of transmitting a conductive path) could also be designed for direct placement over the touchpad device's 600 (the controller input) surface area under a no-slip design; serving to departmentalize the touchscreen device and facilitate adept orientation of a finger input when a touchscreen is being controlled remotely and, exempli gratia, a digital pointer is not present on a touchscreen.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. See related discussions on an attachable thin, transparent overlay. Based on the board language disclosed, the user readily acknowledges that the touchpad device 600 may also be transitioned to a wireless platform, whereas, for instance, a touchpad device 600 may be designed to electronically track the path of a finger input for broadcast (of the articulated directives) to a touchscreen user device, an intermediary transceiver device with attachment, or both, for purposes of manipulating an actionable soft-input.

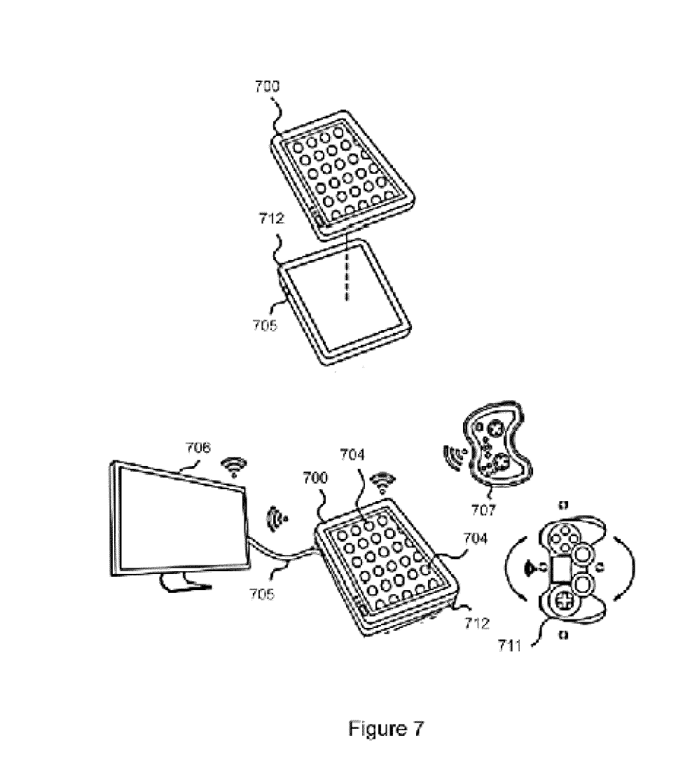

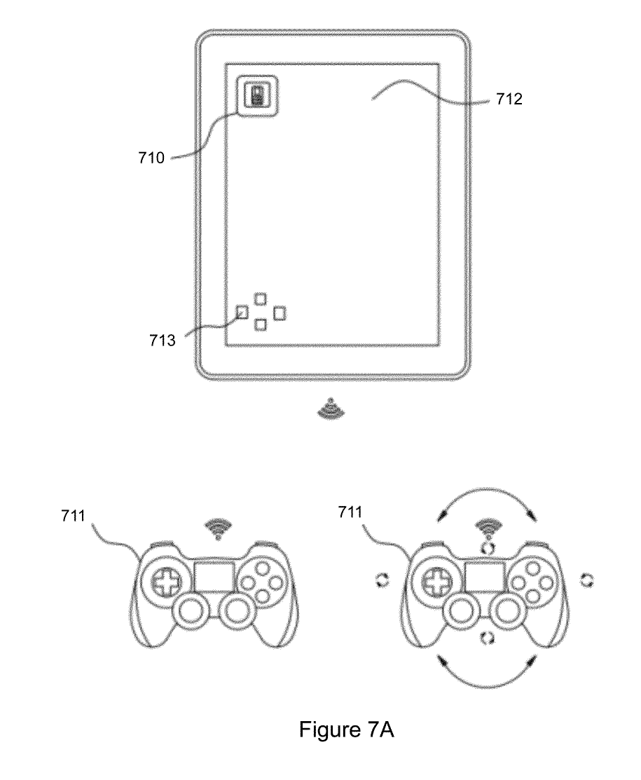

FIG. 7 illustrates an attachmentless-transceiver device 700 with cradle system 701 capable of producing, managing and distributing (directly to the surface of a touchscreen) a quantity of capacitance for the intended purpose of controlling an actionable object displayed on a touchscreen. A grid-like assembly of insulated distribution nodes 704 engrosses the cradle face 701, according to an embodiment of the present invention. The distribution nodes 704 are capable of delivering a capacitive load directly to the soft-buttons and/or related soft-input interface of a docked touchscreen in a manner faithful to an input sequence (associated with a linked input controller 707, operated remotely from the touchscreen user device 703). The present invention, thus, in a bold stroke of disclosure, eliminates completely the need for a wire tether by having the attachmentless-transceiver device 700 with cradle system 701 act as “the attachment interface”, directly, since the touchscreen surface of a touchscreen user device 703 is strategically attached to a plurality of protuberances or distribution nodes upon embodiment engagement. The plurality of protuberances or distribution nodes 704 in direct association with actionable objects on a touchscreen surface, make the actionable objects on a touchscreen directly actuateable in accordance with the parsed and reciprocally (that is, to its correlative output) mapped input-directive counterparts being targeted for capacitive discharge (the correlative output) by the attachmentless-transceiver device 700 with cradle system 701. An effort perhaps further “morphing” a touchscreen user device into assuming more of a role as a “gaming-console”, the impetus of which is an important driver of the inventor's raison d'etre.

Furthermore, highlighting the independence presented by an attachmentless system of controlled capacitive discharge, the attachmentless-transceiver device 700 is a highly-robust assembly that further inspires the revolutionary fold of a touchscreen controller system; with a seamless cadence to interoperability across and between a broad spectrum of hardware platforms, commissioned software and operating systems. Plus, the controller system present under the management of an attachmentless-transceiver device 700 may be designed to provide both wired and wireless interoperability between a mass of non-console and console-based gaming accessories, such as the expansive list of controllers or specialty controllers available in the marketplace, through a process of integral mapping for adroit compatibility by any means serviceable. Integrative mapping, in the spirit and scope of this discourse, may be ushered into a gaming environment, as an example, by virtue of specially designed software programs available for download that are dedicated to serviceable configuration metrics and/or by a range of interoperability syncing tools that may be present “under the hood” upon purchase; with offerings such as an easy-to-employ controller database for readying a selection and integrative-mapping covenants; and other such similar tooling mechanics that may be offered by the attachmentless-transceiver device 700 for purposes of engagement. Any software-configuration and database tools of interoperability, where applicable, may be capable of being updated online, as an example, for current, seamless interoperability of a wide array of foreign controllers into a touchscreen environment.

As per a plurality of related disclosures by the inventor in previous discourse, the attachmentless-transceiver device 700 operates under a likened technological domain of the described intermediary-transceiver devices and is, too, capable of reiteratively producing, allocating and strategically deploying (to a point of capacitive discharge on a touchscreen, as suggested above) a quantity of capacitance under the proficient stewarding of an electronically managed system internal to the attachmentless-transceiver device 700.

Under the teachings of the present invention, the need for a wire tether is, of course, potentially jettisoned by the development of an attachmentless-transceiver device 700 with cradle system 701 that securely accepts the face of a touchscreen user device 703, and more particularly, the germane domain of a touchscreen user device's 703 touchscreen-surface area—and any respective soft-buttons present—to a strategically mapped and comprehensive point of direct, contactual alignment between the touchscreen's surface and the attachmentless-transceiver device 700 with cradle system's 701 distribution nodes 704. As a result, capacitive discharge may occur directly to the touchscreen without the need of, as hereby suggested, an accompanying (wired) attachment interface. This may suggest an operating scenario where a touchscreen user device is placed face down on the cradle 701 of the attachmentless-transceiver device 700; thereby positionally withdrawing its video output. Accordingly, some manner of remote or live output 705 of a touchscreen's rendered contents may be required to occur in its place, though such language is not suggestive of limitation. Projection technologies, without suggestion of limitation, may also prove useful. Beyond broadcast of a standard video output, holograms could be implemented to a touchscreen environment.

Indexing the grid-like assembly of distribution nodes 704 to determine which nodule or nodule plurality is/are in linked association with the engagement of a respective soft-button, soft-button plurality, soft-input and/or any actionable object in a rendered environment, such as that rendered by a refreshing play field during the course of video-game play, may be accomplished by the introduction of any serviceable means of co-ordinate tracking and mapping precepts. Associative mapping software on the touchscreen user device 703, the attachmentless-transceiver device 700 or both, a method subjecting pre-play calibration, structuring a means to capacitate for an indexed title, are all listed as serviceable examples. The reader may refer to FIG. 7A for more detailed and related discourse. Serving to illustrate the process of indexing, an x-axis and y-axis delineation (with more detailed x,y mapping discoursed in U.S. Pat. No. 8,368,662 under common ownership of the inventor) may be referenced. Whereas, in an unillustrated example to facilitate understanding, the actionable soft-buttons of a touchscreen may be hypothetically located at coordinates X1, Y2, X3, Y2, X2, Y1 and X2, Y3 on a touchscreen user device. The grid-like assembly of distribution nodes spanning the cradle interface (integrant to the face of the attachmentless-transceiver device) are electronically indexed into a subset of affiliate (coordinated tracking) distribution nodes based on the determined mapping of their soft-input counterparts. Given the attachmentless-transceiver device 700 is communicably coupled with an actionable-object controller 707 situated remotely from the touchscreen user device 703, as input directives, such as the soft-button coordinates, are entered into the actionable-object controller 707, the input directives are instantly transmitted to the attachmentless-transceiver device 700 for related processing by a microcontroller. An actionable-object controller 707 may be preconfigured for use prior to engagement, where necessary.

The attachmentless-transceiver device 700 manages the input directives for respective deployment of a capacitive charge—with this actuating charge manufactured and/or furnished independently by the attachmentless-transceiver device—across all salient distribution nodes 704 deemed to be “in play” under the aforementioned process of indexing or coordinate tracking, in the order it was received. Furthermore, an actuating charge is instantly levied unto the respective soft-buttons of a touchscreen user device 703 sitting (with its touchscreen surface facing downward) on the cradle, in a manner faithful to the input directives (commencing the cycle of capacitive discharge) received. That is, in keeping with the coordinates' example above, as a soft-button controller is being manipulated, a furnished capacitive charge is regularly and faithfully deployed to a touchscreen—in accordance with the manner the input directives are received from the actionable-object controller 707. Deployment of a requested plurality of capacitive charges upon controller manipulation occurs at the positional touchscreen domain corresponding to the X1, Y2, X3, Y2, X2, Y1 and X2, Y3 distribution nodes 704 earlier ascribed for engagement under the process of soft-button mapping.

A method of live output 705 may be accomplished by availing the use of a Digital AV adaptor or Component and/or Composite AV cable, such as an HDMI AV cable without suggestion of limitation, from the touchscreen user device (source) 703 to an output device 706, usually an HDTV. Alternatively, a digital projector or able projection-device may be enlisted as, alone or in combination with, a method of live output. While technologies such as, as mere example, a dual-sided touchscreen device (with touchscreens furnished on both sides of a touchscreen user-device, and whereas one of the two contained touchscreens may be shielded by an accompanying case during single-screen operation) may be suitable for a cradle system such as that described, without the need for live output, it is not requisite and merely serves as an intellectual mark in signalling the expansive breadth and scope these teachings may yield for subsequent iterations. In a related thought, when under certain operating scenarios not in association with an attachmentless-transceiver device, the merits of a dual-sided touchscreen user device may stand on its own base since it may also offer the benefit of strategically enlisting the use of attachable tactile-controller buttons (in close proximity to where the user's fingers are naturally located on the underside of the touchscreen device when being clutched; perhaps affording a more comfortable and responsive stead. The tactile buttons may be more easily managed and engaged from the described vantage through associative tactile reference by the user and any tactile-button members may be manageably aligned, under conductive extension, to a readily actionable position remote from the soft buttons (on the secondary touchscreen not in view) without the need for repositioning a user's hand—should it be advantageous to do so. This leads the video output of the primary touchscreen being used for natural viewing. Some consumers of the controller embodiment may find this preferable in stead.

An alternate embodiment that builds from this method and assembly (not the subject of illustration), while maintaining the spirit and scope of the disclosure, may find a thin, transparent overlay, capacitively networked by an intricate lining of ITO coatings, attached over a touchscreen of a touchscreen user device, as it sits on the cradle of an intermediary-transceiver device: this time with the screen-side of a single touchscreen facing out for normal viewing. In yet another variant not the subject of illustration, an attachmentless-transceiver device with cradle system could be modified from the design in FIG. 7; whereas the cradle system comprising the comprehensive network of distribution-nodes could be constructed in a manner made to resemble a “viewing window”, that is, a construction design that permits “view-through” or fluent transparency between its traversed depth. On the reverse of this transparent cradle system, for instance, a transparent backing such as glass may be durably etched and/or coated with an intricate network of conductive paths and actuator “tiles” (the nodes) that are under governance of the attachmentless-transceiver device with cradle. The intricate network of conductive paths and “tiles” may be designed such that it permits comprehensive coverage of an associated touchscreen for capacitive delivery for the intent and purpose of manipulating an onscreen actionable object. The system, therefore, provides for the touchscreen user device to be communicably attached (face first) to the reverse side of the transparent cradle system in a manner that honours the subjected conductive paths present in a controller environment, in accordance with the spirit and scope of this discourse. The attachmentless-transceiver device manages the actuateable network; while still affording fluent viewability since the touchscreen's rendering occurs through this “glass window” in a typical vantage. Said, of course, without suggestion of limitation.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. In an operative sense, a touchscreen user device 703 may be “attached” to an attachmentless-transceiver device 700.

FIG. 7A illustrates a rechargeable or battery-powered wireless controller 711 and associated pairing app 710 (control-bearing) integral to the control mechanics of an attachmentless environment for touchscreens 712, this, in accordance with an embodiment. A user notes that regardless of its seeming numerical affiliation, this embodiment may be articulated with or without the use of an attachmentless-transceiver device. As a prelude to controlling game play, a user may download and/or preload an app-based, input/output mapping interface 710 or akin software associated with the wireless controller 711 if he or she has not already done so. Upon installation, a user may then proceed to launch a third-party app that he or she wishes to engage control of with said wireless controller 711 and the input/output mapping interface app 710, running concurrently, may proceed to walk a user through, step-by-step, into configuring/pairing the wireless controller 711 for manipulation of an actionable on-screen object or object plurality, by any serviceable means in the broadened context of the inventive discourse, including, but not limited to, a screen-capture method disclosed herein. The app-based, input/output mapping interface 710, as noted, runs codependently with a third-party app, such as an action game or RPG, and upon launch is targeted for wireless integrative control by initially proceeding to do a screen capture of the current soft-button controller 713 assembly required for operational use. Under the described screen capture, all graphics displayed on a touchscreen 712 are subjected to, for example, a “line-drawing filter” being applied—thus, clearly rendering the respective shape of all touchscreen graphics including the soft-button controller system 713—to facilitate mapping entries for soft-button engagement (not under illustration).

Since the soft-buttons of a soft-button controller 713 are readily delineated by the capture—for instance, through the presentation of four-line (or “empty”) squares representing the touchscreen's 712 soft-button controller 713; with said squares perhaps repeatedly shrinking and expanding in size or “flashing” in their fixed position to indicate they are actionable and ready for configuration with the respective input/output interface app 710. The user then proceeds to tap each of the respective four-line squares of the soft-buttons 713 assigned for control, for instance, and as each is tapped the user is asked to press the correspondent button on the wireless controller 700 to where a wireless signal is then instantly sent from the wireless controller 711 to the touchscreen user device 712 where it may be subjected to processing by a central controller and the app-based, input/output mapping interface 710 software, to “lock” the controller association between the app and wireless controller 711 for the express purpose of controlling a controllable object on a touchscreen. Once all active soft-buttons 713 are associatively paired, a user may commence game play.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. Integration of an intermediary-transceiver device with attachable interface (a possible operating scenario mention; not the subject of illustration) into the involved controller scenario for touchscreens may occur for assistive control of an actionable on-screen object or object plurality, in the spirit and scope of the inventor's concerted discourse, where coveted.

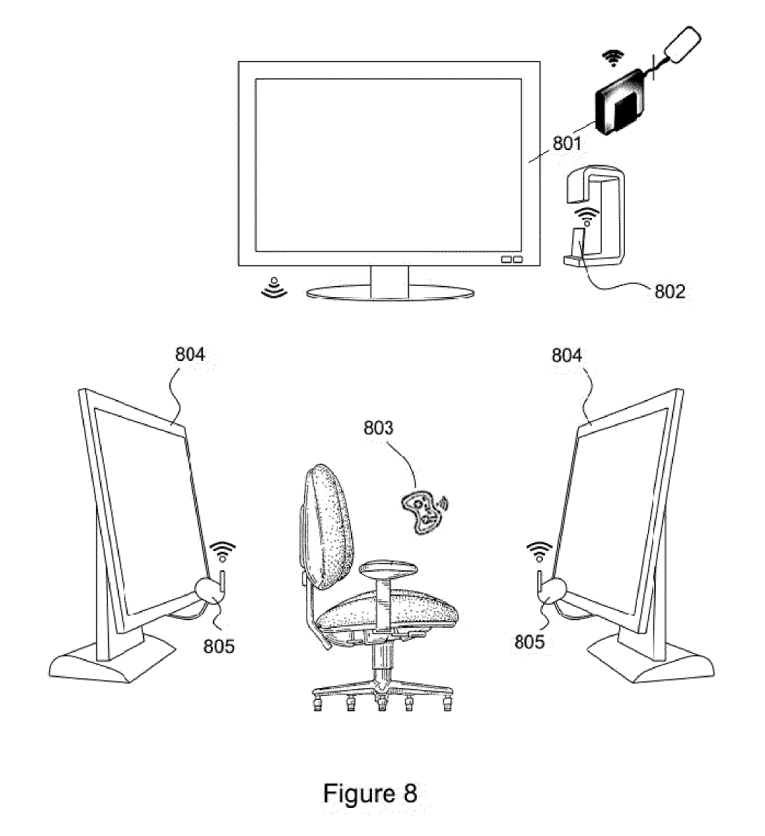

FIG. 8 illustrates a “surround-sense” output or display system (all constituents being equipped with audio capability) comprising a primary television display 800 and a secondary or surrounding display structure 804 designed to provide the user with additional visual depth and dimension in a game environment; with the primary television display 800 housing an integrated intermediary-transceiver device 801 to serve in bolstering controller-interface integration, this according to an embodiment. A primary television display 800 comprises a socket for receiving and/or displaying an intermediary-transceiver device 801. The intermediary-transceiver device 801 is designed to securely dock a variety of touchscreen devices 802 with an interchangeable adaptor head to accompany a variance of touchscreen models. The socket may further comprise a storage bay that is designed for attachment interface or overlay storage. As the reader relates, an attachment interface can be designed for direct attachment to a touchscreen user device 802 such as a tablet or smartphone—but as this exemplary discourse illustrates, direct attachment may also readily occur beyond those hardware platforms to broader electronics such as a television display, including the primary television display 800 unit (which is receptive to touchscreen actuation) as per this embodiment. The rear of the socket may also comprise a jack plurality, associative cable and/or any serviceable output interface for the management of a live output; allowing for less wire clutter to be present, as it allows the wired output mediums to be stowed away for tidy operation. Wire encasement (that is to say, placed internally where a wire is not viewable), facilitative docking assemblies and plug-and-play connectivity without a visible wire endowment, may also be spirited to the socket construction to the present invention. The socket and intermediary-transceiver device 801 with attachment, collectively, may serve to streamline a touchscreen gaming system and experience. Under this exemplary discourse, since the intermediary-transceiver device 801 may be, for the sake of example, directly built into the television unit, it attempts to become more gamer friendly for those aspiring to “take the action to the big screen”, by default.

The control-unit processor and capacitance station of the intermediary-transceiver device 801, for example, permit for the supply and conveyance of internally-furnished capacitance to a docked touchscreen user device 802 such as a tablet (or, in the case of a “non-docked” environment, borrowing from this exemplary discourse, potentially including the television itself as the touchscreen device) without the need for the direct finger (control) input of a user when attempting to manipulate an actionable object. The intermediary-transceiver device 801 proficiently manages the act of capacitive transition in a manner faithful to the input directives received from a remote-wireless controller 803, as per the spirit and scope of this discourse. A secondary (surrounding) display structure 804 may be formed, without suggestion of limitation, by virtue of proximate placement of two television displays screens (or the rounded-display systems of the future) in the “line” of a user's “peripheral-vision centre”, for added sentience to game play.

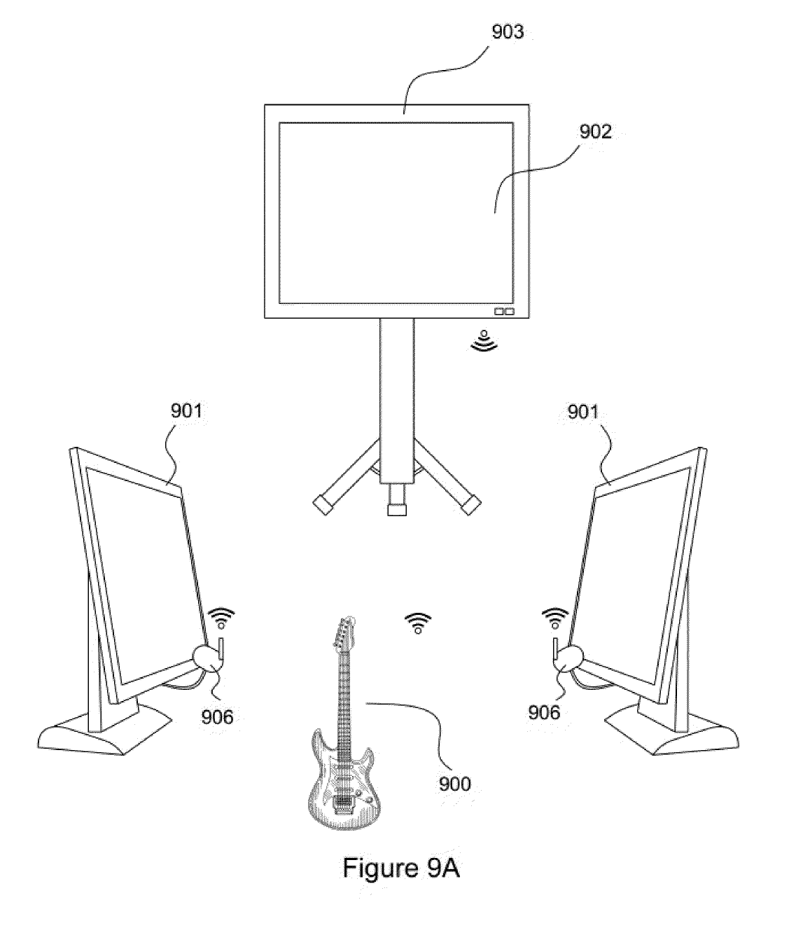

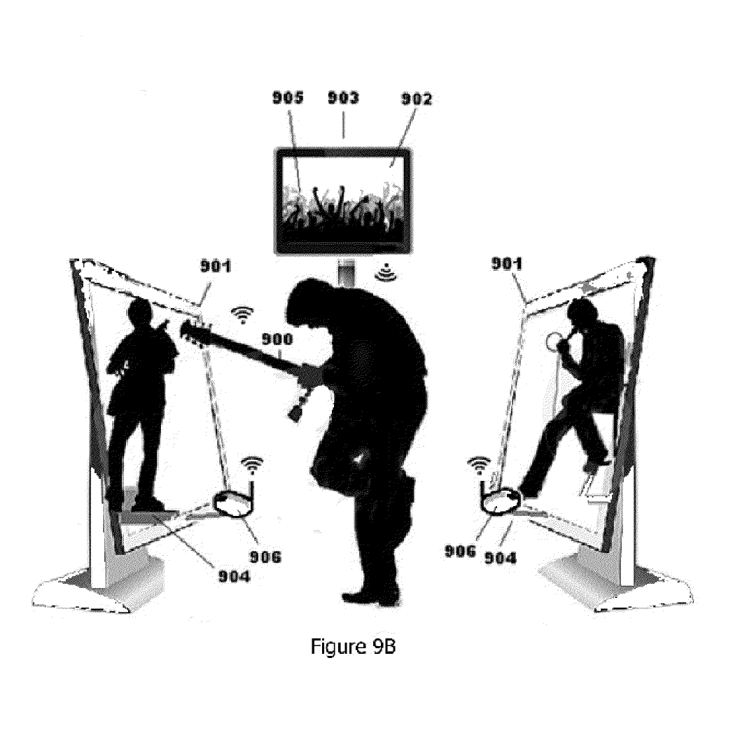

Current gaming environments typical involve only a primary display 800 device. The panoramic system described herein may provide for added peripheral dimension to immerse the user to a heightened sense. Software programs, such as app-based games, can be programmed for integrative use with both a primary display 800 device and secondary (surrounding) display structures 804 to enhance the “peripheral-vision centre” of the user. To wit, synchronized rendering between the secondary (surrounding) display structure 804 (a peripheral output) and the primary television display 800 (primary output) presents a user differing vantages for each video display device. Thus, to serve as an example, if a user's vantage spans that of a football field (with a view towards the end zone) or a hockey rink when looking forward from centre ice (towards the goal net; as shown on a primary display), the secondary (surrounding) display structure 804 may focus on the respective boards, bleachers, player's bench, advertising banners, crowd, etceteras, on each side of the user by nature of the display arrangement and the subject gaming matter. The fluid vantages may occur in real-time, proportionately with the related changes of a primary display device 800 and secondary (surrounding) display structure 804; as, for instance, all vantages may be influenced by a user input (the reader may refer to FIG. 9B for related discourse accompanied by illustration). In the immediate, as a user moves, and/or a controller is moved, forward, based on the cited example, all three display vantages (and potentially a linked audio casting, as well, with a strategically placed speaker assembly) are generally updated accordingly.

The secondary (surrounding) display structure 804 may, for instance, also comprise a plurality of peripheral output projection units 804, in place of electronic displays, with a plurality of wirelessly-equipped projection devices 805 casting a game's renderings on the surrounding display structure's 804 “backdrop”, according to a variant embodiment recognized in illustration. At the bottom of each projection screen 804, for instance, a small, wirelessly equipped projection device 805 may be mounted to furnish its projection on a proximal projection screen 804 as shown. Each wirelessly-equipped projection device 805 may receive rendering directives from a remote user device or touchscreen user device 802; directives while complementing the changing renderings of the primary television display 800, are, of course, disposedly different to account for naturally-changing vantages (an attempt at “real-world” simulation) to fan the impetus of added periphery impact to the gaming experience. As a user is positioned at the inset of both peripheral output projection units 804 (both projection screens, in this example, with care by the user not to block the natural “projection line” with his or her positioning for optimum visual delivery). The wirelessly-equipped projection device 805 is ideally mounted to provide the user with a fluent range of motion without the advent of visual encumbrance during active game play.

Furthermore, the workings of a peripheral-vision display system will be illustrated further in FIG. 9B by virtue of the integration of a specialty-controller input into a gaming environment. An exemplary operating scenario is illustrated by a “snippet” of the primary-to-periphery integrated output that is concurrently influenced by a user. Use of the term “snippet” applies to a static frame, of course, that is snapped for illustration purposes of the combined (primary-to-periphery) display structure renderings, as each display structure is designed to virtually render by refreshing in real-time and may be constantly evolving from that shown by “snippet”.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. An HDTV touchscreen device may comprise a built-in intermediary-transceiver device 801 with attachment. An external intermediary-transceiver device with attachment may be further supplied in varying embodiments.

FIGS. 9A-B illustrate a “surround-sense” output or display system (all constituents being equipped with audio capability) comprising the primary output display 902 of a touchscreen user device 903 and a secondary (surrounding) display structure 901 designed to provide the user with additional visual stimulus, such as perspective, depth and dimension, in a touchscreen controller environment, in accordance with an embodiment. Noted in this exemplary discourse, an integrative and attachmentless-controller system 900 (an innovative, wireless specialty-guitar controller, without suggesting of limitation, for integrated gaming) is introduced in direct wireless communication with a touchscreen user device 903 running an affiliated game app; to not only capably input control directives, but also to potentially influence the content rendered in a multifaceted display system, including a primary display 902 of a touchscreen user device 903 (also acting as a hosting device) and secondary (surrounding) display structure 901. Unlike associative illustration in FIG. 8, as per the discourse centred on this embodiment, the primary output display 902 may sit centrally suspended at the perimeter or edge of the visual “zone” of the surrounding (peripheral) display structure 901 to provide the user with a more “encircling” view when, for instance, facing the primary display 902, without suggestion of limitation in arrangement, breadth or scope of the associated discourse.

A specialty guitar-controller 900 may comprise sensors such as, but not limited to, gyroscope and location services to help determine, for example, positioning vantage and “on-stage” mobilization for related communicable rendering to the plurality of output devices associated with the “surround-sense” output system. As the user moves forward, to add colour by example, the rendering by the projection device 906 on the projection screens 901 of the secondary (surrounding) display structure 901, on both sides, will each uniquely correspond by displaying a vantage-relevant or “forward-scroll” visual 904 (FIG. 9B) of the stage, in this case showing the adjacent bandmates, while the primary screen 902 (the touchscreen of the touchscreen user device 903) will concurrently show the audience 905 (FIG. 9B) and theatre balcony getting bigger. The associated example of integration between all associated output screens and the controller input (the specialty guitar-controller 900) is for illustrative purposes only and would be subject to recurrent change based on the fluid dynamics of game play in a real-time environment.

As suggested, and in further elaboration, both the controller-integration and visual-assembly impetus of this embodiment may be subjected to marked variance from the proposed illustration, while still remaining within the spirit and scope of this discourse. For instance, the user may interchange and/or substitute the components of the display structure (and alter the output arrangement, from this figure, as coveted) and further introduce a Component and/or Composite AV cable or Digital AV adaptor into the assembly. A television equipped with touchscreen functionality and acting alone as the host device of the particular gaming title, with the television capable of downloading and engaging its own inventory of apps, may also be a popular operating scenario. A third projection screen and projection device—perhaps at the dorsum, adding to the “surround-sense” output or display system associated with the embodiment or perhaps in altogether replacing the primary output of a touchscreen user device—may, in further instance, also be added to an output schema, if coveted.

Furthermore, a wired specialty-guitar controller with attachment may be used in place of the wireless variant under a single and/or multifaceted display environment. Applicable game apps, such as popular note-streaming flavors (that stream musical “notes” down a screen in an assembly-line-like fashion) governing a touchscreen device, can be designed to work with—or work, arbitrarily, under a mutable or adaptive conterminous attachment—a specialty guitar-controller. The specialty guitar-controller may undergo a design change from the previous inventor discourse whereas the “strings” may be replaced with a plurality of touch-engaged, pressable conductive bars (with said bars running along the neck of the specialty-guitar controller) for finger placement and capacitive engagement upon depression (in, for instance, a wired variant). The touch-engaged, pressable conductive bars may be serviceable by wire tether; or any serviceable tether in broadening the discussion, with each respective bar seeing its wire tether channelled (or conjoinedly channelled in linked association with a conductive counterpart) along a conductive path to a capacitive-discharge element of the capacitive-discharge overlay—the attachment interface serving as a modal capacitive output to a touchscreen. Upon touchscreen attachment, the capacitive-discharge element, responsible for a pressable conductive bar, will actuate a corresponding soft-button upon the conclusion of a conductive path first mobilized by the capacitive finger engagement of a touch-engaged, pressable conductive bar. The touch-engaged, pressable conductive bars may, of course, also be serviceable by wireless tether (the default embodiment) in the spirit and scope of this discourse.

In direct association with a television host device, an embedded transceiver device may be introduced to add broadly to the spectre of gaming titles available for play on the “big screen” and for robust controller manipulation, but such embedded technology is not requisite, for instance, as input controllers may be communicably (wirelessly) engaged and then reconciled with a user device directly under the ascendency of, exempli gratia, associated co-ordinate tracking or mapping software. Mapping software is designed to seamlessly integrate a remote input or controller device, such as the specialty guitar-controller, with its soft-button (a corresponding input) controller counterparts for the intended manipulation of an associated actionable object or object plurality rendered on a touchscreen. Since this controller disposition is based on mapping software, an output interface normally responsible for the act of physical mapping is not required. Incorporation of an integrative and attachmentless-controller system 900, a communicable or wireless system, into a brethren touchscreen controller environment, may, of course, also occur with other such innovative touchscreen controllers previously introduced by the inventor in common-ownership filings (both known by example of the inventive discourse and those associated with the breadth and scope of its teachings).

Such innovative touchscreen controllers may include, but are not limited to, racing-wheel, disc-jockey, bowling-ball, hockey-and-golf-based, drum-set and dance-pad themed specialty controller assemblies, along with the empowerment of motion-based input controllers, all previously transitioned to a touchscreen environment by the inventor. But this list is hardly expansive. To add a few more controller examples to the list to suggest the magnitude of breadth and scope carried by the inventor's teachings, the ever popular games such as whack-a-mole, darts, air hockey and other such entires are readily transitioned to a touchscreen controller environment (in both wired and wireless offerings) as per the inventor's teachings. The reader will note the premise of direct wireless integration between a revolutionary specialty controller (such as an inspiring bowling-ball controller) for touchscreens and a touchscreen user device, without use of an intermediary-transceiver device, is discussed, most recently, in Priority application Ser. No. 13/249,194 with the USPTO. Certain gaming titles could also be specifically designed for use with such novel controllers exclusively in a system that may displace the need for active touchscreen input or the disposition of soft buttons, entirely, and thus, in this sense render the touchscreen user device as more of a “passive-device” used primarily for related processing and output rendering and, potentially, as a manager of controller influence that is both available and not available under the umbrella of traditional soft-input and/or soft-controllers. In other words, certain game functions could only be initiated with the use of specialty controllers under the accordance of specially designed code available in a software selection. Furthermore, a touchscreen user device running on such a specially-designed software selection may be transitioned such that it is not responsive to or intended to interact with the direct engagement and/or control input (or touch) of a finger, under certain gaming realms. This may even lead to operating scenarios whereas the soft-button controller may, in fact, be entirely removed from display on a touchscreen and the subject of remote operation is steered in an unanchored setting of becoming more “visually-and-controllably seamless”.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation; may operate directly, in wireless mode under an established duplexing system, with its linked partner (e.g., a touchscreen user device by virtue of a serviceable mapping system), thereby potentially displacing the need for an attachable physical interface. Operating scenarios related to the select controller environment may include a specialty controller with attachable interface and/or an intermediary-transceiver device with attachable interface. Wireless disposition of a specialty controller in communicable engagement with (and amongst) a touchscreen user device 903 and/or an intermediary-transceiver device or both is serviceable in a communicable-exchange (under the governance of both transmitting and receiving) environment.

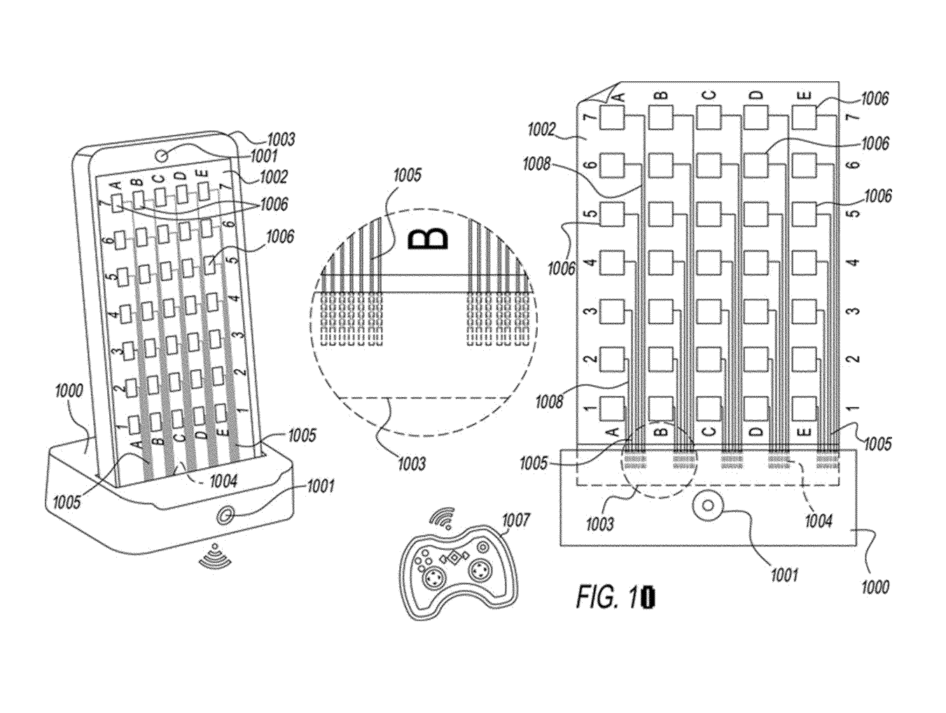

FIG. 10 illustrates, in accordance with an embodiment, a small intermediary-transceiver device 1000 with camera 1001 and attachable capacitive-discharge overlay 1002 that primarily function, in the aggregate, for the dual purpose of docking a touchscreen user device 1003 and the controlling of an actionable object rendered on the touchscreen of a touchscreen user device 1003; by substantive virtue of: a dock-connector assembly (not illustrated) to which a touchscreen user device 1003 sits securely attached; a capacitive-discharge overlay socket 1004 to which a capacitive-discharge overlay 1002 is received for relay of a targeted capacitive discharge, as governed by a small intermediary-transceiver device 1000; and a communicable input device or device plurality 1001, 1007 with associated mapping software.

The small intermediary-transceiver device 1000 with camera 1001 and attachable capacitive-discharge overlay 1002 may be integrated, by a wiring scheme, to the dock-connector pin system of the dock-connector assembly for sourcing power from a touchscreen user device 1003. The dock-connector assembly receiving the touchscreen user device 1003, for instance, comprises a dock-connector pinout assembly and is wired in a manner, such that, the ground and voltage pins—along with an appropriate resistor—may be engaged in a circuit upon the docking of a touchscreen user device 1003; whereas the associative wiring scheme is designed with the objective of powering the small intermediary-transceiver device 1000 with camera 1001. In alternate iterations, of course, the pinout assembly responsible for providing power, under this embodiment, may be replaced with an alternate power supply such as, but not limited to, a voltage source (such as a battery supply) or a current source (such as power supplied by a traditional home electrical socket).

The associated camera 1001 of the small intermediary-transceiver device 1000 (or, in variant embodiments, tracking by an associated camera 1001 may be limited to those associated camera's 1001 embodying a touchscreen user device 1003) is capable of fluently tracking, for instance, an accredited hand-based gesture and, according to FIG. 10, remains under the management of a microcontroller central to the small intermediary-transceiver device 1000. The associated camera 1001, may, for instance, amongst a list of other accredited input-gestures, be capable of tracking a finger swipe, an articulated finger input or input plurality, directional gesture and/or a targeted engagement of touch (to actuate a soft-button, for instance) that may be motioned within a “capture zone”, to name a few. A “capture zone” refers to the given range of the viewfinder associated with a camera-tracking system responsible for the objective of motion-input determination. Upon the tracking of accredited input directives based on camera-discerned motion input, the capacitive manager of the small intermediary-transceiver device 1000 with camera 1001 and capacitive-discharge overlay 1002 is engaged to respectively relay an innately-supplied capacitive charge to a correlative exit point 1005 tether of the capacitive-discharge overlay 1002. The relay of an innately-supplied capacitive charge serviceable to this embodiment occurs by virtue of the capacitive-discharge overlay 1002 being contactually inserted into the integrated capacitive-discharge overlay socket 1004 with pin configuration—with each pin being capable of distributing a capacitive charge.

Whereas, upon actuation of a prescribed conductive channel and/or channel plurality with a targeted capacitive-charge distribution by associative pin disposition (reiteratively, by virtue of the conductive alignment between the exit points of a capacitive-discharge overlay 1002 and the distribution pins of a capacitive-discharge overlay socket 1004), a targeted domain on the touchscreen of a touchscreen user device 1003 is actuated via the routed network of the capacitive-discharge overlay 1002 (an output interface). A distribution element or “tile” summoned for engagement of a targeted domain, resides amongst a comprehensive disposition array of tiled elements comprising the capacitive-discharge overlay 1002 and has its network skillfully managed by the microprocessor of the small intermediary-transceiver device 1000, without suggestion of limitation. The targeted domain (or strategic points of capacitive distribution) may be, for instance, points associated with finger-based input tracking such as a swipe, tap or akin accredited gesture processed through the camera lens of an associated camera 1001, to name a few. The liberation of remote operation avails, regardless of the manner of controller disposition. Actionable-object mapping based on the conductive network of a capacitive-discharge overlay 1002, may, of course, be replaced with electronic mapping supplied by an associated software program running on a touchscreen user device 1003 that provides, for instance, an orientation point, such as a cross-hair or on-screen pointer that may be manipulated by a wireless input controller 1007, or conversely, the potential jettisoning of the need for an orientation point by virtue of mapping preregistration of all necessary soft-buttons in synchronized relation to the input buttons of a wireless input controller 1007. Orientation points could, of course, also be influenced by accredited camera gestures in a related controller environment. This embodiment, or any stipulated in this application, for that matter, is not in any propensity suggestive of limitation.

The capacitive-discharge overlay 1002 is designed from the principles discussed in FIGS. 5 and 6, whereas a thin, transparent overlay sees an initial application of an Indium-tin oxide (ITO) coating 1006 on both its face and rear surface (to ensure element conductivity throughout the overlay upon layering only in the areas treated or coated with the ITO) in an arrangement that may equally departmentalize (an assembly of equal parts or “tiles”, with adjacent borders serving as insulation) the capacitive-discharge overlay 1002 for fluent touchscreen assimilation across all salient screen domain. Communicably bordering, from a coated tether maintained throughout, the initial application or set of ITO coatings 1006 (the assembly of squares or “tiles” responsible for capacitive discharge) are a separate subset of conductive coatings or channels conjoinedly applied to each ITO deployment 1006 on the upper surface of the overlay only (to safeguard against unintended transmission, that is, transmission of a capacitive charge through the capacitive-discharge overlay 1002 and onto a touchscreen, along an entire engaged conductive path 1008—1008 in this case is an example of a single independently channelled conductive path that occurs amongst a plurality of similar conductive paths 1008 correlatively linked [and not all labelled] in the tiling association—traversing the touchscreen). By design, only the areas intended for transmission of a capacitive charge, such as an Indium-tin oxide (ITO) coating 1006 or element associated with a coordinate on the touchscreen area being targeted for capacitive discharge, will be engaged as the conductive path is traversed intently along the network's surface (with channelled routing along the upper surface of the overlay) of a capacitive-discharge overlay 1002, attached to a touchscreen, to a targeted touchscreen conclusion. Said differently, the only point of realized actuation (by capacitive discharge) that occurs as a conductive path traverses the entire conductive channel of a capacitive-discharge overlay 1002 is at a targeted “tile” member or associative element. Targeting determination may be based on either the manipulation of a wireless input controller 1007 or accredited camera gesture, this according to the present embodiment and not suggestive of limitation.

The small intermediary-transceiver device 1000, in concert with its coupled capacitive-discharge overlay 1002, are able to fluently honour a conductive path from the ITO origin 1006 up to and including an exit point 1005 at the bottom of the capacitive-discharge overlay 1002. Once input directives of a wireless input controller 1007 are determined by the microcontroller unit of the small intermediary-transceiver device 1000, a capacitive charge is supplied or relayed to an exit point 1005 (with the “exit” point actually serving as the engagement point of a quantity of relayed capacitance by a small intermediary-transceiver device 1000) of the capacitive-discharge overlay 1002—also referred previously as a thin, transparent overlay—communicably networked or linked to an Indium-tin oxide (ITO) coating 1006 element to strategically honour an induced conductive path. A small intermediary-transceiver device 1000 with camera 1001 and attachable capacitive-discharge overlay 1002 may further be embedded into a display device, such as a HDTV, for direct touchscreen engagement of the touchscreen TV and the processing of input directives of an associated wireless input controller 1007 may be replaced and/or supplemented with the processing of input directives associated with an associated camera 1001.

Under this exemplary operating scenario, without suggestion of limitation, whereas if a swipe gesture in an input cycle is determined by camera 1001 to occur at the bottom, right-hand corner of a framed capture range, for example, a capacitive charge may then be deployed (for related actuation) by the small intermediary-transceiver device 1000 along a designated conductive path to an ITO-coating 1006 or conclusion element (the targeted square or square plurality in a series) associated with the bottom, right-hand corner of the touchscreen. An HDTV may serve, in a further instance, as “a trackpad” of sorts, where the camera's viewfinder maps an omnidirectional range in proximity to the location in which a user is standing that is associated with “framing a gesture”, which in this exemplary discourse may rely on using the actual HDTV screen as the frame or “canvas” in which a user may conduct gestures for associative mapping. Directional inclination may be mapped based-on proximate gesture and then translated to, for instance, an HDTV in real-time or, in the case of operating scenarios involving both a mobile touchscreen device, such as smart phone or tablet, and HDTV, where a touchscreen user device's output may then be updated to the associated HDTV in real-time. Of course, a similar method of tracking and engagement could be transitioned for use without the use of an intermediary-transceiver device 1000 where the associated camera 1001 of a user device is instead engaged (or in addition to a transceiver device) and a serviceable introduction of co-ordinate tracking and mapping software on the user device is introduced for purposes of manipulating an on-screen actionable object. An infrared video camera, in an example suggesting both breadth and scope, can also be integrated into a system of gesture input where a plurality of stretchable finger caps or thimbles, for example, are introduced; where said caps may be designed to radiate a quantity of serviceable heat emission for a progressive means of tagging a finger-based-gesture input.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. See capacitive-discharge overlay 1002.

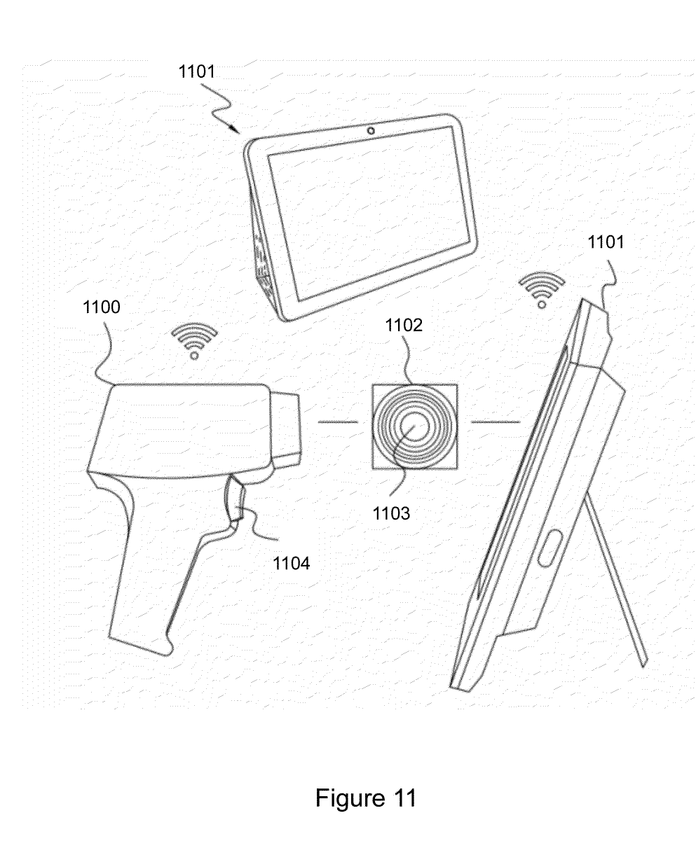

FIG. 11 represents an actionable-object aimer controller 1100 assembly, as interposed in a touchscreen 1101 environment. An actionable-object aimer controller 1100, serving as a touchscreen-input device or controller input, is a lightweight plastic controller comprising a processor, wireless transmitter and an image-capture device 1102; such as a digital camera 1102 equipped with an extremely narrow viewfinder frame. By design, the viewfinder frame may only be capable of capturing a very limited image (for instance, a small section of the active touchscreen display of a touchscreen user device 1101), with said viewfinder image positionally influenced by directing the actionable-object aimer controller's 1100 focal point 1103 or lens—in accordance with an embodiment.

As an actionable-object aimer controller 1100, for instance, is wirelessly paired to a touchscreen user device 1101 featuring a compatible game title, upon the engagement of a projecting tongue or trigger 1104 at the handle top of an actionable-object aimer controller 1100, by a user, a wireless directive is instantly transmitted to the user device causing the image on the touchscreen to rapidly flash an alphanumeric rendering uniquely identifiable to a specific touchscreen location. For instance, upon application of a trigger 1104, the rendered output of a touchscreen sees an alphanumeric rendering instantly flashed (at a fraction of a second so it is not even discerned by the user) across an entire touchscreen for related processing. To facilitate understanding, an example rendering may include the following: a1a2a3a4a5a6a7a8a9a10b1b2b3b4b5b6b7b8b9b10 . . . z1z2z3z4z5z6z7z8z9z10 for parsing. An encompassing rendering such as this is immediately classified into screen coordinates for related processing and, in conjunction with the simultaneously captured snippet image of a limited geographically-identifiable alphanumeric rendering by an actionable-object aimer controller 1100, a process of cross-referencing occurs instantly to determine an exact location captured on a touchscreen 1101, thereby allowing any mapping software program present on the touchscreen user device 1101 to manipulate and/or engage an actionable-object at a highly precise location (that “photographed” or captured by the limited viewfinder of the aimer device) on the touchscreen 1101, accordingly, during the course of game play.

To expand on this discourse further, if an actionable-object aimer controller 1100 pointed at a touchscreen 1101 captures, for instance, the flashed digital-image snippet 7a or z7 of the alphanumeric rendering noted above (reiteratively, the image captured within the limited range of the viewfinder, the determination of which will serve as precise coordinates of a touchscreen 1101 capture) upon trigger 1104 application, the actionable-object aimer controller 1100 will then wirelessly transmit these captured coordinates to the touchscreen user device 1101 for related processing and respective actionable touchscreen-coordinate engagement. An actionable-object aimer controller 1100's driver software and/or mapping software may be, for example, programmed to consider screen-size determination and distance between the input device (an actionable-object aimer controller 1100) and touchscreen user device 1101 to best asses the pattern of pixilation produced by the image capture results (of the flashed rendering) upon trigger activation. OCR software may also be incorporated into the actionable-object aimer controller 1100, touchscreen user device 1101 and/or both, amongst other means serviceable, to assist with parsing the screen capture (digital image) into precise coordinates for the accurate wireless relay of directives to a touchscreen user device 1101.

For those gamers potentially seeking greater compatibility across a variety of platforms and operating systems with less of an onus on software compatibility and/or calibration requirements, the inventor discloses a further iteration in an effort to address greater controller independence and freedom of operation. According to an actionable-object aimer controller variant to that disclosed above, a receiving device and related disposition assembly for touchscreens is introduced comprising an infrared-sensor plurality (such as a plurality of photodiodes) designed to collaborate with an infrared emitter comprising a touchscreen-input device, such as a light gun designed for casting against the surface of a receiving device capable of coordinate detection of a projected light beam, as it is transitioned to a video-game environment for touchscreen interfaces.

A receiving device and related assembly comprising an infrared-sensor plurality, in this exemplary discourse, is preferably sized in a way that conspicuous remote viewing—such as that occurring from across the living room floor—by a user is possible. The infrared-sensors of the sensor plurality are divided for even distribution across the entire receiving device's surface area, in a manner that departmentalizes each sensor to proximate a “finger-span” size in order to effectively manage (and prepare for associative touchscreen mapping) the entire surface area of the receiving device for correlative touchscreen actuation by electronic association, through, for instance, a communicable system of coordinate mapping between both the receiving device and the touchscreen user device, in response to a manipulated controller input. Across the face of the entire receiving device, in a proximal manner, an acrylic (break-resistant) mirror—capable of transmitting, or traversing through the mirror depth in its entirety, controller-born input communications such as an aimed light projection beam or light-beam casting—is securely positioned.

The broadcast image of the touchscreen user device reflects onto a relay mirror, prone to angular manipulation, in such a manner that it reflects the broadcast image right-side up onto said acrylic mirror encasing the face of the receiving device. In this way, a user will see the exact rendering—overcoming the properties of reflection according to its design—of the touchscreen's broadcast on the mirror's surface, and thus, be able to cast an infrared beam “directly” onto a game's broadcast-image rendering at its reflection point on the mirror surface (which, of course, traverses through the mirror depth to the respective infrared sensors immediately below the mirror's surface, thereby permitting sensing of a coordinate input). Management of a coordinate input under a microcontroller influence of the functional receiving device, in the spirit and scope of this discourse, permits identical coordinate actuation directives (e.g. a precise touchscreen mapping point) to be relayed to a touchscreen user device for appropriate response to an input controller signal. A carnival game, for instance, with a plurality of tin cans strewn across a line on its display screen, may see a can knocked off its mooring if its position represents the coordinate point captured by the receiving device. Identical touchscreen mapping requires communicability (for example, in a wholly wireless disposition) between the various hardware components and any engaged software for faithful input gesture translation to a touchscreen user device from the initial cast to discharge.

Disposition of an actionable-object aimer controller variant (an input device) may be transferred to a touchscreen user device, in the spirit and scope of this discourse, for respective actuation by any means serviceable, including through integration of a capacitive-discharge overlay borrowing from the principles discussed in FIGS. 5 and 6, amongst others, where a thin, transparent overlay (that may be subjected to verbatim layering) sees an initial application of a transparent Indium-tin oxide coating on both its face and rear surface (to ensure conductivity throughout the overlay in only the areas coated with ITO) in an arrangement that equally departmentalizes (an assembly of equal, parts with the adjacent borders serving as insulation) the capacitive-discharge overlay for fluent touchscreen assimilation across all salient screen domain. Communicably bordering, from a coated tether maintained throughout, the initial application of transparent Indium-tin oxide coatings (the assembly of squares or “tiles” responsible for capacitive discharge) are a separate subset of conductive coatings or channels conjoinedly applied to each ITO deployment on the upper surface of the overlay only (to safeguard against unintended transmission, that is, transmission of a capacitive charge through the capacitive-discharge overlay and onto a touchscreen, along an entire engaged conductive path traversing the touchscreen). By design, only the areas intended for transmission of a capacitive charge, such as an Indium-tin oxide (ITO) coating or element associated with a coordinate on the touchscreen area being targeted for capacitive discharge, will be engaged as a conductive path traverses intently along the network's surface (adjacent to a touchscreen) of a capacitive-discharge overlay, attached to a touchscreen, to a targeted touchscreen conclusion. Said differently, the only point of realized actuation (by capacitive discharge) that occurs as a conductive path traverses the entire conductive channel of a capacitive-discharge overlay is at a targeted “tile” member or associative element.

A small intermediary-transceiver device that may be embedded in the receiving device, in concert with its coupled capacitive-discharge overlay, are able to fluently honour a conductive path from an ITO origin (or tile) up to and including an exit point at the bottom of the capacitive-discharge overlay. Once input directives of an actionable-object aimer controller variant are determined by an associated microcontroller unit of the receiving device (with embedded intermediary-transceiver device), a capacitive charge may be supplied or relayed to an “exit” point (now serving as the engagement point) of the capacitive-discharge overlay associated with the calculated coordinates of an aimed light projection beam as its projection is contactually registered with the receptive sensors of a receiving device.

According to an analogous iteration describing transitional adaptation to a touchscreen, an infrared light emitter station comprising an infrared light emitter plurality is used; whereas the infrared-light emitter station, upon broadcast, collaboratively engages both a remote infrared sensor (such as a photodiode) and distribution of angle sensors housed on a touchscreen-input device, such as a light gun. As a trigger is depressed on the light gun, for instance, the intensity of an incoming IR beam projection, for example, may be detected by an engaged infrared sensor responsible for surveying a coordinate origination (determination by virtue of a controller input; the light gun). Intensity is based on factors of angulation and distance to the infrared-light emitter station and the present method and assembly described allows a trigonometric equation system to be solved for calculating light-gun positioning relative to an infrared-light emitter station. Once respective angles of a broadcast agent (the infrared light) are determined by the angle sensors, as an infrared sensor receives an incidence of projection from the infrared light-emitter station, for example, a point of impact is electronically calculated for correlative touchscreen actuation in the spirit and scope of this discourse. A method deploying ultrasonic sensors, for instance, in place of IR emitters, may also be serviceable to this discourse and those skilled in the art will appreciate the broader implications of this embodiment in its transitionary discourse to a touchscreen environment. Where impact-point precision is of less importance, designs may be adopted where angle detectors are instead replaced by, for instance, a quantity of 4 IR sensors for related integration. Furthermore, 3 or more IR emitters, each with varying wavelengths and paired with the same quantity of sensors, are variants to this discourse that allow for angle determination relative to the 3 or more emitters (with 3 emitters, 3 angles are processed) upon calibration and can be further adapted for integration into a touchscreen environment, although such articulation in this paragraph is not accompanied by illustration.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. For possible attachment interjection in an associated controller environment, the reader may refer to the related teachings of a capacitive-discharge overlay and an intermediary-transceiver device with capacitive-discharge overlay—both of which may be embedded in a related receiving device under a different method and assembly. In a potential wired light-gun variant, an attachable interface stemming from a corded assembly of wires configured and networked, by any serviceable means, for actionability of the salient domain of a touchscreen is presented. As a screen determination is made under capture, for example, the microcontroller unit (with central processing unit) in the light-gun—in concert with an innate capacitive source—may direct and supply an innate capacitive source to a targeted area on the touchscreen associated with the captured screen determination. Wireless variants may, of course, be interchanged with a physical-interface assembly under a related operating scenario, as described in a preferred embodiment that remains wholly wireless.

FIG. 12 illustrates a physical skeet-ball controller 1200, as it is transitioned to a touchscreen 1201 environment; whereas a physical skeet-ball controller 1200 is integrated with a virtual setting and the play dynamics, as influenced by a physical skeet-ball controller 1200, are injected in a skeet-ball game being played and/or rendered on a touchscreen, in accordance with an embodiment of the present invention. A physical skeet-ball controller 1200 comprises a runway 1202 and distribution plurality of equally-spaced concentric rings 1203 remote from the runway. The concentric rings 1203 are spaced sufficiently apart such that a skeet-ball prop is able to fit freely between all associated rings. Each concentric ring of the ring plurality 1203 may be equipped with sensors to instantly sense gravitational contact with a skeet-ball prop 1204 after a launch has concluded; this for point determination and score tracking in a virtual refresh cycle. Said differently, the triggering of a ring sensor, for instance, may result in a ring value wirelessly communicated to a user device upon the instance it was calculated; for real-time integration into the virtual game-play associated with a touchscreen-based user device 1201. The physical skeet-ball controller 1200 may contain a microcontroller unit (processor) to manage the controller environment and can be wirelessly equipped for fluent interaction with a touchscreen user device 1201 in the communicability of input directives received. Communicable directives—or the wireless exchange of directives related to associative game play—occurring between a physical skeet-ball controller and touchscreen user device, as suggested above, is instant, thus permitting the touchscreen display of a touchscreen user device 1201 to be refreshed or updated in real-time. Alternatively, without suggestion of limitation and in emphasis of a wide net of serviceability for a coveted objective, each ring of the concentric ring plurality 1203 may comprise a motion-sensing device designed to detect motion triggered by a skeet-ball prop 1204 as it passes through (not the subject of illustration) a respective ring. As a user launches a skeet-ball prop 1204 across the runway 1202 and towards the scoring rings 1203, for example, as a ball finds and travels through a ring, an associative value is determined and said value is then instantly transmitted, wirelessly, to a touchscreen user device 1201 for related-virtual or digital integration. Related-digital integration may include, but is not limited to, real-time updating (such as in score keeping) and refreshing of the renderable content (such as in injecting colourful score-based graphics upon registered scoring).

As a skeet-ball prop 1204 is launched, a tracking sensor on the launch pad is engaged, resulting in wireless directives instantly broadcast to the user device to delineate the act of launching on a touchscreen—resulting in a coinciding graphical rendering, for instance, of the launch-based associated input. As a skeet-ball prop 1204 progresses and completes the launch path or runway and “threads” or engages a specific ring (and a respective ring value is determined), the virtual flight path is instructed for a graphical conclusion. Varying speeds, flight paths; may, as a case in point, be processed by the central processor of a controller in accordance with a time-stamp determination derived from mapping the launch initialization (as the runway first senses the launch) to the completion of the runway path and beyond, including travel through any of the concentric rings 1203 or the skeet ball prop 1204 coming to a position of rest against a respective concentric ring of the ring plurality 1203, in order to virtually account for differing launch actions and for accurate real-time synchronization with a touchscreen's game play. Serviceable mapping sensors, for instance, could be further integrated beneath the sheathing of a controller base in order to precisely measure flight path; including through a mapped point of a respective “ring path” conclusion, for added real-time synchronization, as coveted.

Under such specialty controller environments, a gaming app, such as a skeet-ball app presently under consideration, without suggestion of limitation, may present users with a choice of controller engagement upon the launching of the app. For instance, the user may be presented with the choice of: a “finger swipe” input (with perhaps the finger drag length and drag speed determining the properties of the throw); or a specially-purpose controller input outside of the touchscreen's 1201 touch interface, such as the integration of a physical skeet-ball controller 1200, as illustrated. A physical controller could also be replaced with a mode of controller input relying on remote gesturing based on the interaction of a user's gestures with a camera device, such as one that may be present in the user device (not the product of illustration). A camera device, of course, may also be associated with an intermediary-transceiver device and attachment interface present in contrasting iterations; with said camera device used alone or in combination with a camera device associated with the user device, as coveted. To wit, for those garners potentially seeking greater compatibility across a variety of platforms and operating systems with less of an onus on software compatibility and/or calibration requirements, the inventor discloses a further iteration revealing a touchscreen-overlay attachment (not the subject of illustration) of an intermediary-transceiver device. Although the interaction between a physical skeet-ball controller 1200 and touchscreen user device 1201 may be written into the software game's code by the respective programmer or programmers, according to this exemplary discourse, other serviceable means of integration may occur, such as an introduction of an independent software program designed to both map and coordinate a physical-controller input counterpart, such as a skeet-ball controller serving as a controller input, with a skeet-ball app concurrently running on a touchscreen-based user device for related actuation.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. For possible attachment interjection in an associated controller environment, the reader may refer to the related teachings of a capacitive-discharge overlay (or touchscreen-overlay attachment) and an intermediary-transceiver device with attachable capacitive-discharge overlay. The overlay may stem from the physical skeet-ball controller 1200; operating under the ascendency of an internal capacitive management and distribution system in accordance with an ancillary controller environment (not the subject of illustration).

FIG. 13 illustrates a basketball-net controller 1300 assembly for integration into a virtual-basketball or digital-gaming environment of a touchscreen universe, such as an app based on the rapid-fire shootout games present in arcades or amusement parks, with the attributed discourse corresponding to an embodiment. According to an operating scenario, the basketball-net controller 1300 may operate in relation to a gesture-sensing camera of a touchscreen user device 1301 and/or a camera or camera plurality present in any integrated and serviceable device, not limited to a touchscreen platform. The basketball-net controller 1300 may contain a sleeve that securely accepts a touchscreen user device 1301 on the reverse side of the backboard of a basketball-net controller 1300; to facilitate camera perspective and to protect against incidental contact with a foam basketball prop 1302 associated with the basketball-net controller 1300. Certain metrics, for instance, such as the arc of a shot, the speed of a shot, the base position of a shot, basket mechanics, etceteras may be capably tracked and leveraged, for more in-tune or “responsive” incorporation into a virtual environment, by an associated gesture-sensing camera. Under the situation where a ball rolls around the rim before dropping in, for instance, this type of ball behaviour could be skillfully tracked by an installed gesture-sensing camera or camera plurality for wireless updating to a touchscreen user device 1301—for a respective touchscreen rendering—in real time, under the stewarding of a central processor and the wireless association inherent in the controller exchange. Of course, a gesture-sensing camera or camera plurality may further be leveraged in alternative, “propless” embodiments (not the focus of discussion) free of a physical controller.

The basketball-net controller 1300 primarily comprises a foam-based basketball prop 1302 and associative basketball net 1303 and backboard 1305; with optional stand or door-mounting bracket 1304. The basketball net 1303 and backboard 1305 may comprise a vibration sensor in association with the rim of the basketball net 1303; with said vibration sensor capable of sensing contact with the foam-based basketball prop 1302 for related integration into a game-play environment. For instance, if the foam basketball prop 1302 is judged to have hit the rim of the basketball net 1303 upon a user's shot, an audible and graphical “clank” may be produced on the touchscreen of a touchscreen user device 1301, with either the foam basketball prop 1302 falling in or out of the basket thereafter for respective touchscreen 1301 rendering. For those instances where a user shoots and threads the mesh without incidental rim contact, the virtual rendering of an integrative swish may then be instantly presented, for assimilation, as the virtually associated touchscreen 1301 refreshes. Colour or play-by-play commentary, such as announcers enthusiastically proclaiming swish shots or a quality round of shooting, may, for instance, also be added to the game environment. For the purpose of tracking a scored basket, for instance, an additional sensor or sensor plurality may be incorporated into the rim's mountable bracket 1306 or optional telescopic stand (not the product of illustration), where applicable, in a manner that proficiently registers a successful basket for related integration of (the actions of) a physical prop into a virtual environment, in real-time; conforming similarly to assimilation-based objectives (the intended tracking of a physical modal input for purposes of transitioning said modal input into a virtual environment), as discussed in FIG. 12.

An additional sensor or sensor plurality may be present in the backboard for added graphical and audio representation on a touchscreen user device 1301, whereas, as the foam-based basketball prop hits the backboard, for instance, both an audio effect is produced (a resounding “bam!”) and a visual iteration is translated to the touchscreen of said backboard contact in response. For door-mounted operation, a “curved slide” with a flat, 90-degree backing for positioning against the door surface directly underneath the basket, with a wide-enough lip and long enough runway to both catch and adeptly guide a “flushed” ball back to the user for “quick-fire” re-throws. A plurality of foam basketball props 1302 may be added to a gaming environment to, for example, produce a higher tempo in play. A basketball-net controller 1300 assembly is thus presented, one affording the user added realism, physical play and excitement associated with a prop-based, modal-input environment, in the spirit and scope of this discourse.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. A touchscreen-overlay attachment may be modelled into said controller disposition. The reader may refer to the related teachings of a capacitive-discharge overlay (or touchscreen-overlay attachment) and an intermediary-transceiver device with attachable capacitive-discharge overlay. The overlay may stem from the basketball-net controller 1300; operating under the ascendency of an internal capacitive management and distribution system in accordance with an ancillary controller environment (not the subject of illustration).

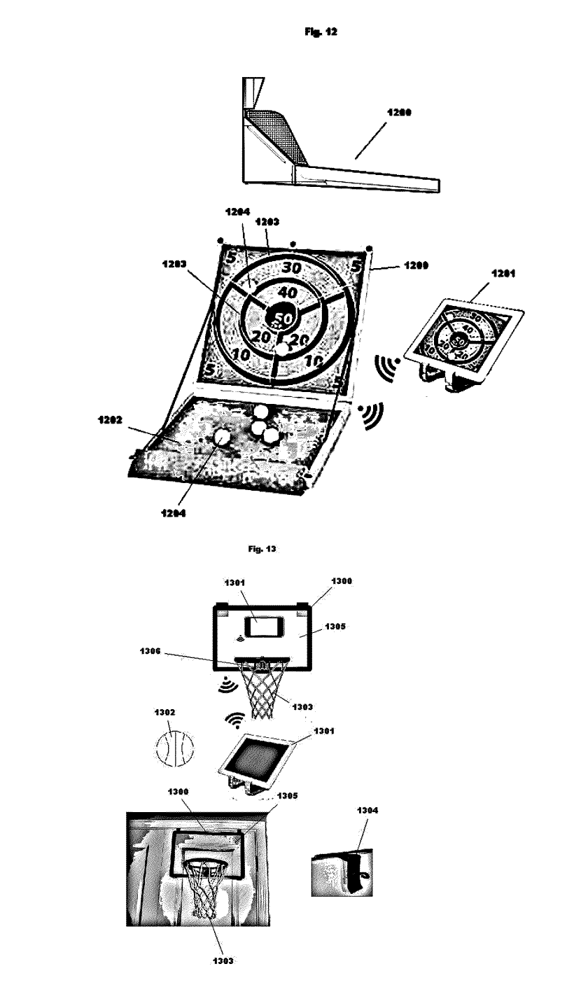

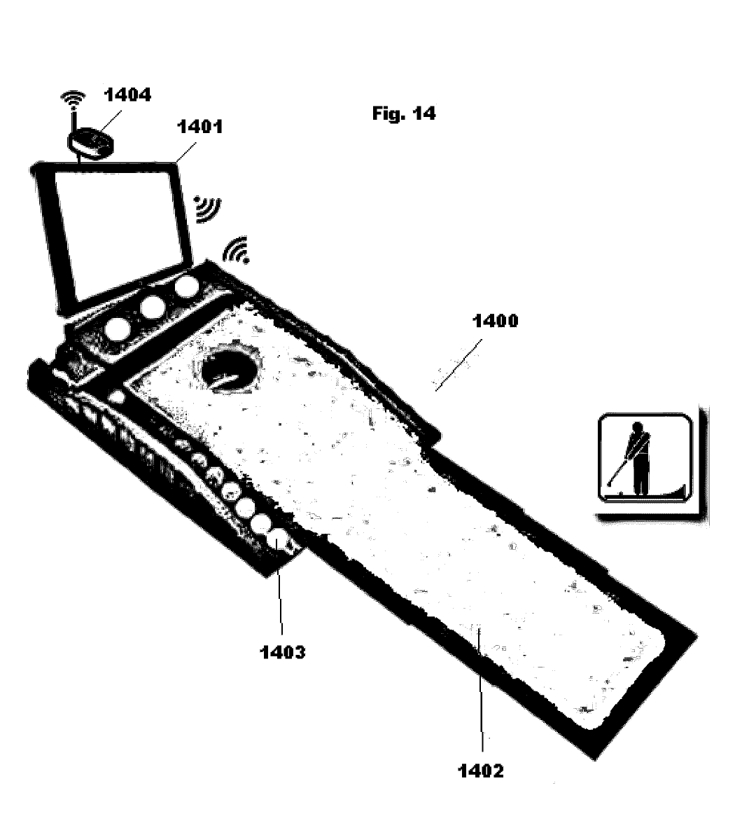

FIG. 14 illustrates a mini-golf pad controller system 1400, as transitioned into a touchscreen 1401 environment, this according to an embodiment. The mini-golf pad controller system 1400 comprises a mini-golf pad 1402 equipped with a quantity and arrangement of a sensor type, as designed to fluently track the traversal path of a putted golf ball 1403 across its surface. Sensors may include, but are not limited to, magnetic, motion, weight, infrared and/or camera-based, to name a few serviceable to this discourse. Under a touchscreen 1401 controller system where a physical controller is integrated into a virtual-gaming environment, novel game dynamics are borne and the potential gaming experience, raised. For embodiment purposes only, under a sensor disposition where a camera-based tracking system of a putted golf ball 1403 is enlisted, a camera of a touchscreen-based user device 1401 and/or an autonomous camera device 1404 are both serviceable in the objective of determining the traversal path of a putted golf ball 1403; for implementation into a virtual environment.

An autonomous (digital) camera 1404 is mounted in position such that the entire mini-golf pad 1402 falls within its digital viewfinder or within frame. The autonomous (digital) camera 1404, in conjunction with tracking-based software associated with the touchscreen user device 1401, the mini-golf pad controller system 1400, and/or the autonomous (digital) camera 1404, provides for the capable tracking of a putted golf ball 1403 across the entire path assembly; including into a recessed hole—typically located remotely from the putting green's putt line—that a user targets with his or her ball. A putted golf ball 1403 could, in addition and for depth of example, be marked or equipped with a facilitative-tracking medium, such as, but not limited to, a heated core that further permits precise tracking across the surface of the mini-golf pad 1402 using specially equipped cameras (capably of ferreting heat traces) introduced to the controller system, if so coveted.

Removable and interchangeable props, acting as obstacles, may be introduced to a gaming environment for related tracking and injection into a virtual environment. Hollow rocks (made from a thin plastic shell, for example), movable blocks, pegs, a water patch and other such obstacles to the hole may be added variably to the mini-golf pad 1402 surface, thus yielding a greater degree of complexity to game play, and may be tracked using an equipped autonomous (digital) camera 1404 and translated into a virtual environment by simulating the shape and placement of the obstacles virtually through viewfinder association and mapping. The mini-golf pad controller system 1400 may be wirelessly equipped for dynamic interaction with a software program being rendered on a touchscreen user device 1401, allowing for real-time updates, hazard tracking and more.

According to an embodiment where only an integrated camera of a touchscreen-user device 1401 is used, the mini-golf app, an auxiliary mapping app, or both, in association with an underpinning of tracking metrics measurable by the camera of a touchscreen user device 1401, may be used, as an example, to map or departmentalize an entire touchscreen into an array of tiny recurrent (and independent) squares for related actuation. A coordinate plurality of the tiny recurrent squares in an array will be indexed to an input sequence (in a mapped association) for fluent and precise graphical representation of a registered controller input, such as a putt across the mini-golf pad 1402. As a touchscreen user device 1401 processes a ball path's motion directives through the discerning lens of its internal camera (and shared controller-system processor), it instantly delineates unto the display filed of a game app, in real-time, the measured path across the tiny recurrent squares associated with the controller mapping derived from a physical environment. In this way, a physical environment again meets a virtual environment; for an heightened gaming experience.

The touchscreen user device 1401, in association with a running software program and/or app, may, for example, keep track of all related mini-golf scores, statistics and related game metrics to keep the user apprised electronically and even usher in such features as, but not limited to, the virtues of providing the user or users with instant replay and a listing of most-memorable moments through recordable history. For effective storage management, a mini-golf pad controller system 1400 may also be adapted into other specialty controller input devices by, exempli gratia, software modification, a minimizing design (such as a collapsible and foldable elements of a controller), comprising an interlocking system or snap-together system that is easily assembled and/or disassembled to a desired position, or any manner serviceable to this discourse. As a case in point, the mini-golf pad controller system 1400 may see fluent and rather seamless conversion to the golf or hockey-stick based controller assemblies discussed in previous patent applications with little effort on the part of the user, without suggestion of limitation.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. For possible attachment interjection in an associated controller environment, the reader may refer to the related teachings of a capacitive-discharge overlay (or touchscreen-overlay attachment) and an intermediary-transceiver device with attachable capacitive-discharge overlay. The overlay may stem from the physical mini-golf pad controller system 1400; operating under the ascendency of an internal capacitive management and distribution system in accordance with an ancillary controller environment (not the subject of illustration).

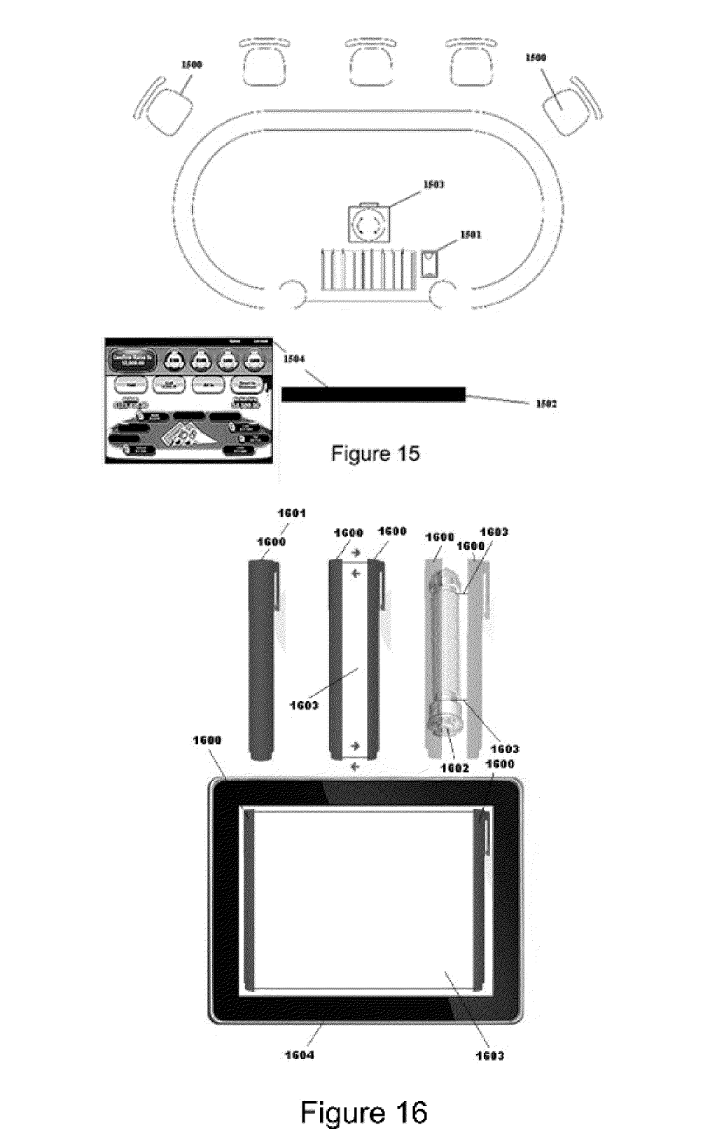

FIG. 15 suggests a method and assembly designed around a card-playing system, with a physical controller interface, deck presence and a mechanical distribution system, as transitioned and integrated into a virtual setting for use on a touchscreen device, this according to an embodiment. Devices beyond mobile-touchscreen devices, such as, but not limited to, smart televisions, may also be assimilated into the gaming environment discussed herewith. Those skilled in the art will appreciate the expansive breadth and scope of accompaniment related to the teachings of the present invention. Attempting to meld real-life gaming activity, this in a card-player setting, to the virtues of a virtual domain, is the impetus behind the embodiment of the present invention. This in contrast to the traditionally “one-dimensional” and often-limiting, “control-input-of-a-finger” soft interfaces associated with touchscreen gaming. Of course, the actual physical playing cards described in the controller environment herein, may, exempli gratia, also be replaced by communicable handheld devices that dynamically update to a virtual playing environment (dynamic shuffling, dealing or the distribution of cards, scoring tables, dealt hand, etceteras, may all presented to a user virtually on said handheld device) in an interactive environment comprising a single user or group setting. Communicable handheld devices replacing a physical card disposition may also operate in conjunction with a remote display system capable of independent rendering (for instance, a display system that renders content independent of the content displayed on the handheld device).

A user 1500 is requested to place a card deck on a card shuffler/reader apparatus 1501 for mechanically shuffling and reading through the entire plurality of cards in the given deck, for storage into memory of a touchscreen device 1502 or associated controller hardware for streamlined play. An interactive touchscreen device 1502, through an intuitive menu offering supplied by a running software program, such as an app, presents the user 1500 or user plurality 1500 with a choice of card games to select and is displayed in a prominent location with its dynamically-updating display 1504 visually accessible to all users 1500. Upon completion of the shuffling and reading actions associated with calibrating a deck for game play and then having the results stored into resident electronic memory, a communicable mechanical “dealer” 1503 system is enlisted; which may then prompt a user 1500 to place the deck of cards in an accompanying slot of the mechanical “dealer” system 1503. The mechanical “dealer” 1503 system will then deal the cards to the respective players 1500, previously registered as being present, at a table based on the card metrics of the selected game play. The mechanical “dealer” system 1503 is an apparatus that employs an internal delivery mechanism to mechanically deal out the playing cards. Having previously scanned the cards into electronic memory prior to game commencement for dynamic updating on the main display 1504 where applicable, the reader/shuffler apparatus 1501 with processor—in wireless association with a microcontroller of the mechanical “dealer” 1503 system—initiates a transfer of data to the mechanical “dealer” 1503 system responsible for maintaining operational updates based on, for instance, the process of card distribution. The process of card tracking, of course, remains fluid during the course of game play; helping with such game dynamics as, but not limited to, digitally rendering 1504 those cards which are typically visible (amongst those not visible; a process that is refreshed with ongoing card distribution) as they are dealt on a card table for increased visual engagement and acuity for such games as poker, player requests for additional cards and the determination of a winner, to name a few.

The mechanical reader/shuffler 1501 and/or the mechanical “dealer” 1503 system continues the process of tracking until the conclusion of a winner in the hand and then repeats the process until card depletion of a shuffled deck; whereas a user or users may then be instructed to place the cards back into the associated shuffler/reader 1501 apparatus tray (e.g. face down) for reshuffling prior to redistribution. Having integrated a touchscreen device 1502 for wireless communication with the integral components of a card-playing system described, including a remote mechanical shuffler 1501, reader and counter apparatus that is capable of tracking cards for digital translation on a touchscreen device 1502 (using, for instance, embedded OCR software), exemplary discourse relating the fluency of the virtual integration of a physical environment is described using a highly atypical input controller assembly, such as a mechanical shuffler/reader 1501 and mechanical “dealer” 1503 system serving to input directives to a touchscreen device 1502 in a highly evolving environment. As a player hand is dealt, for example, by virtue of wireless communication between the integral hardware, this hand can be digitally processed by the associated software of the touchscreen device 1502 for fluent assimilation into the game's dynamics.

The tracking of accredited hand gestures by a user 1500, by an associated camera or camera plurality, could further be employed in a card-playing environment. Hand gestures linked in a card-playing system could, to illustrate by example, be leveraged to indicate such gestures as holding (with, for instance, a user's upright hand facing forward as to indicate an intention to stop) or asking for additional cards (with, for instance, a hand facing the user and folding forwards, with a small number of repetitions that may be necessary for hand-gesture registration) and be subjected for integration into the virtual game play. The camera and related software program can be designed to understand a broad number of gestures beyond this simple exemplar narrative, as coveted. The user-device camera, too, can be made to pan to each player just as a central touchscreen display system indicates it is their respective turn for an input decision, such as to hold, fold, ask for cards, etceteras and may be refreshed in real-time on the display 1504. The display system 1504 offers splitter (e.g. picture-in-picture or PIP) capability for providing multiple viewpoints of a fluid environment.

A user-device camera—or an associated camera or camera plurality linked to a card-playing controller system—may be positioned such that it permits capture of the full range of activities associated with the card table, including determinant activities such as, but not limited to, delineating the number of users at the table (this may also be accomplished, for example, by virtue of IR-based player position sensing in the associated hardware; a IR-based system which may also be used for accurate card distribution along with ultrasonic sensors to help determine the depth of card delivery), active players during gameplay, decisions to fold or request additional cards, including the act of card retrieval, managing the array of dealt cards, etceteras are all capably tracked for associative controller input using a gesture-sensing camera and associative software program and remain fodder for the reciprocate and germane rendering occurring on the refreshing touchscreen 1504 of a touchscreen device 1502. Even casual body gestures, without suggestion of limitation, such as slumping or in waving side-to-side can be digitally integrated on a touchscreen device's 1502 display 1504. Digital-based visual ads, such as the addition of independent video clips to a card-playing environment or a background setting appropriated with corporate sponsors, interesting statistical facts and trivia, recorded video clips of memorable moments during present game play (perhaps selected using indicators such as, but not limited to, loud bursts of audio above a certain threshold where a camera may be instructed to pan across the table), etceteras, are serviceable to this embodiment.

FIG. 16 illustrates a cylindrical tube 1600, assuming the appearance of a fountain pen 1601, that is incised in two proximate halves designed to easily separate and reattach to each other to form an assembled whole. Upon separation of the cylindrical tube into proximate halves, a retractable mechanism 1602 is presented. The retractable mechanism 1602 ushers a short, rolled length of flexible transparent or reasonably transparent material 1603 to a locked position between the two proximate halves of the cylindrical tube 1600 as they are drawn apart to conclusion. The two proximate halves seek attachment, by any means serviceable, at their base, to a touchscreen user device 1604 and, upon attachment, serve as a typing aid for a touchscreen's 1604 virtual keyboard by presenting the flexible transparent or reasonably transparent material 1603 at a proximal distance from a touchscreen surface; such that it allows both hands to rest upon it without an incident of unintended actuation, while still permitting intended finger application (depression of the transparent or reasonably transparent material 1603 to the touchscreen's 1604 surface for intended actuation) to the touchscreen. Soft-button actuation by finger depression is, of course, attributed to the flexible properties of the transparent or reasonably transparent material 1603.

A mounted inner tube, comprising a retractable mechanism 1602, nests in the primary half of the cylindrical-tube 1600 shell by, for example, without suggestion of limitation, mounted brackets (at the top and bottom). The transparent or reasonably transparent material 1603 sees anchored attachment to the retractable mechanism 1602. A spring mechanism with a tightly-wound spring and ball bearing (designed for locking at full extension) is responsible for the extension and retraction of the drawable transparent or reasonably transparent material 1603. As the drawn flexible transparent or reasonably transparent material 1603 is positioned for manipulative engagement above the surface of a touchscreen, the material remains of proper tension to ensure that gentle hand rest by a user is permitted; without concern for unintended actuation of the soft-keys (from the resting weight of the hands) below it. The afforded tension of the flexible transparent or reasonably transparent material 1603, nevertheless, does still afford the user the ability to administer intended finger application (fluent depressing of the flexible transparent material above a coveted soft key to the point of soft-key actuation—the material returning to its position of rest upon deapplication). A “pen clip” may be included on the shell of the cylindrical tube 1600 for the added mobility and convenience of easy pocket storage.

Exemplary methods of attachment (of the two drawn proximate halves) to the touchscreen 1604 device may include, but are not limited to, suction-based appendages, of any serviceable design, perhaps protruding from the shell exterior or, under a different method, perhaps through the incorporation of a slotted groove (internal to the cylindrical tube 1600) on each proximate half; with each slotted groove flexibly designed (for instance, through a flexible rubber lip) to securely accept the edges of a touchscreen 1604 user device for purposes of engagement, when drawn accordingly. Pinch clamps and related rigging assemblies are further serviceable to this discourse, though not necessarily considered a preferred method of attachment, as they may add bulkiness to the portable device. A matrix-seeking attachment to a virtual keyboard, with a corresponding physical tether extending operation, remotely, to a tactile keyboard mounted across the surface of a foldable case, may serve as an alternate deployment for a tactile-based typing aid for a virtual keyboard setting and reprises (discussed by the inventor in a previous application) investor-taught fodder for intellectual thought.

In stark contrast with the method and assembly above, a wireless embarkment that does not rely upon either an attachable interface or the control input of a finger, may be introduced. And while the following wireless embodiment may still assume the appearance of a fountain pen and offer the same convenience of be highly transportable, this is essentially where the similarities end. A cylindrical tube constructed to house an electronic assembly with microphone (not the subject of illustration), is operated by voice prompts, voice dictation and speech-recognition software. As a user dictates into the speech-to-text device, a voice input is transcribed for purposes of communicably engaging the virtual keyboard of a touchscreen user device. Whereas, for instance, a Bluetooth keyboard uses a tactile keyboard for wireless data entry in association with a paired touchscreen user device, this embodiment replaces the tactile keyboard with a voice-driven input device. A simple touchscreen-user device app may be designed to integrate a voice-driven input device, such as the one described here, with the input protocol of a virtual keyboard for the intended actuation of mapped soft buttons in the spirit and scope of this discourse.

Attachment characteristics potentially attributed to the particular embodiment: While the following exemplary discourse may suggest a practicable application of an “attachment interface”, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. The reader may refer to the attachable characteristics related to the two incised proximate halves of the cylindrical tube 1600; each purposefully designed for touchscreen attachment.

FIG. 17 illustrates controller integration between a radio and/or remote-controller 1700 device and a mounted touchscreen device 1701 designed to purposely and collaboratively control, in accordance with an embodiment, a remote-controlled car 1702 operating within both an enclosed physical track 1703 and a virtual environment. A user is thus faced with the added difficulty of having to manoeuvre around digital obstacles 1704 placed in the radio-controlled car's 1702 potential path on a digitally-refreshing touchscreen 1701. The reader notes that a touchscreen may act, primarily, as the user's “dashboard display” of sorts; for integration of a physical car into a virtual environment. To facilitate said “dashboard display”, a touchscreen 1701 user device is placed within a centrally-mounted receiving slot of a radio and/or remote-controller 1700 in a manner that displays the touchscreen user device 1701 for fluent viewing. A camera of a mounted touchscreen user device 1701 or, where applicable, an integrated and communicably paired camera of the radio and/or remote controller 1700 device, engages its viewfinder to comprise a quantity of salient content for the display area of the mounted touchscreen user device 1701 as a game is being rendered.

Said differently, what the viewfinder captures, acts as a “layer” of display in the display area of the touchscreen user device 1701 and becomes “part” of a game's digital rendering. In this particular embodiment of game play, the backdrop or background of the rendered game play may thus be more situation specific to a physical assembly (that, for example, captured and integrated into a gaming environment by the viewfinder) and less reliant on the written software code of a gaming app, with a software program typically supplying the graphics entirely on its own (with the potential for melding of both virtual and physical backgrounds in a widely varied manner, of course, being elementary). While the physical image or backdrop being captured by an engaged camera's viewfinder may comprise a fundamental allotment (a primary backdrop, for example, of an engaged game) of the rendering of a visual display on a given touchscreen user device 1701, it is nevertheless complemented by digital renderings 1704 such as, but not limited to, obstacles (rocks, competing cars, water patches, ditches, etceteras), game text and dialogue and digital twists and turns superimposed on the “live” touchscreen 1701 display or that comprising the digital viewfinder's field of capture 1701. The user may readily track the path of the radio-controlled car 1702 by watching its operation through the “viewfinder” or touchscreen 1701 display, by design. Under this method, the touchscreen 1701 is mounted in such a way that, as the radio-controlled car 1702 is operated, the user readily sees both the radio-controlled car 1702 and related track and the interposed digital renderings 1704, concurrently. The added difficulty is presented where a user must manage a series of “digital” obstacles 1704 in a “physical” environment; with actual physical cars being controlled remotely.

The radio-controlled car 1702 may be readily tracked by an associated camera (or by, for instance, sensors and/or the incorporation of tracking markers, or any serviceable tracking device, on the remote-controlled car 1702) for assimilating the path of a physical radio-controlled car 1702 with any associated digital renderings (rocks, competing cars, ditches, etceteras) detailed on the touchscreen. An associated camera may, of course, work in concert with an integrated software application that capably integrates the virtual and physical world for tracking-and-engagement based purposes of a radio-controlled car 1702 in relation to its virtual environment.

The radio-controlled car 1702 may contain-a servo mechanism, controller and associative wireless hardware capable of sending and receiving signals to and from the radio and/or remote controller 1700, touchscreen user device 1701 or both for real-time integration, such as when the physical radio-controlled car “collides” with a digital obstacle, a signal, for example, may be transmitted to the radio-controlled car to be temporarily disabled or thrown from its intended path, accounting for the “collision”. A servo-mechanism, as a case in point, can be engaged to disorient and/or positionally alter the path of a radio-controller car while in motion. Due to the smaller size of an enclosed track, a motor with different speed settings may be introduced to the radio-controlled car 1702 for greater degree of control. Haptic control feedback may also be present.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. For possible attachment interjection in an associated controller environment, the reader may refer to the related teachings of a capacitive-discharge overlay (or touchscreen-overlay attachment) and an intermediary-transceiver device with attachable capacitive-discharge overlay; which may be introduced in divergent operating scenarios. The capacitive-discharge overlay may stem from the radio and/or remote specialty controller 1700; operating under the ascendency of an internal capacitive management and distribution system (and/or a capacitive charge supplied by a user), in accordance with an ancillary controller environment (not the subject of illustration).

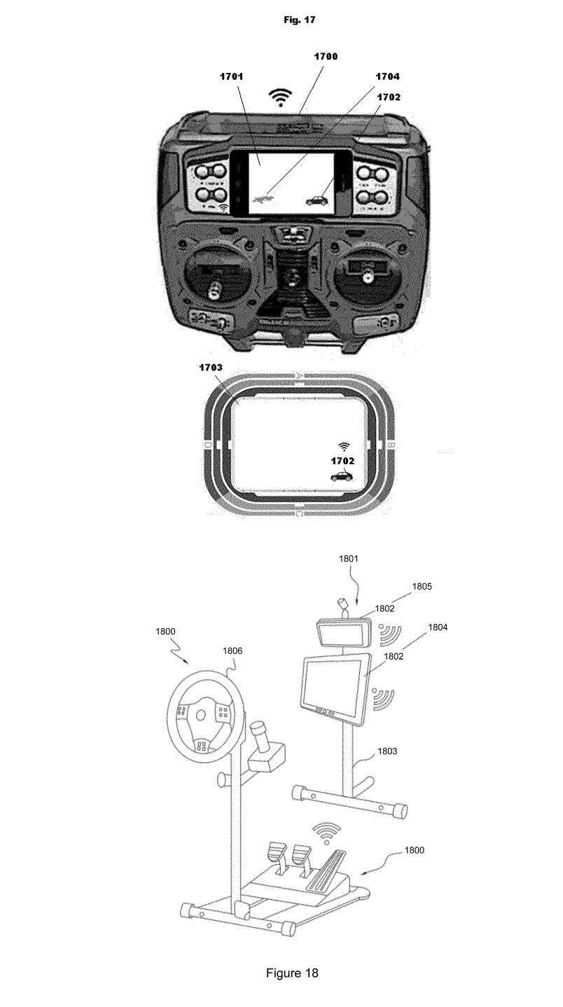

FIG. 18 illustrates a wireless racing-wheel controller 1800 and coalescent audio/visual assembly 1801 designed for operational and allied use in a race-themed environment for touchscreen user devices 1802, this according to an embodiment. The coalescent audio/visual assembly 1801 of a racing-wheel controller 1800 system comprises a vertical and centrally-mounted suspension arm 1803 with mounting assembly; designed to securely and prominently suspend both a tablet 1804 and smaller mobile device 1805 in a manner such that the visual-display component of a tablet device 1804—of course, having the larger screen versus its mobile phone brethren 1805—is mounted proximally to a user's natural field-of-view (placed in an area acting, in sorts, to mimic a “windshield” view) during engagement of a racing-wheel controller 1800. In an area just above the clearance of the top of the tablet device 1804, the suspension arm 1803 is further extended to provide support to a smaller mobile device 1805, such as a smartphone, in manner that mimics the involvement of a “physical” rear-view mirror in a game environment.

Each of the racing-wheel controller 1800, tablet 1804 and smartphone device 1805 can be wirelessly equipped to interchangeably send and receive integrative directives, between each other, in a harmony of rendering and controller input. Whereas both touchscreen user devices 1802 are equipped for wireless engagement, for instance, each touchscreen user device 1802 may receive a unique broadcast signal from the racing-wheel controller 1800 or complementary touchscreen user device 1802 during game-play events such as, to cite but one example, when a tire is blown out and the shredded rubber is ejected onto a race circuit. As the centrally-mounted tablet 1804 provides rendering in real-time of a forward-looking orientation, the supported smaller smart device 1805 provides for a “rear-view” orientation, with perspective (and rendering producing that perspective) akin to a real-world environment. Thus, a written software application may be used to articulate two distinct views between each visual field of view in an evolving manner—the front view or tablet view 1804 (the road ahead) and the rear view or smartphone view 1805 (showing cars fast approaching from behind, for instance). Given the tablet device 1804 may contain the race-themed application and be labelled a primary device, at least according to an embodiment, it may be wirelessly linked and responsible to the smaller smart device 1805 for the majority of game dynamics, for instance, for matters such as “uploading” to it the rear-view screen's delineatory views that are associated with the smaller mobile (second) device 1805.

A smaller mobile device 1805 may also have the identical gaming app concurrently synched and operational for more thematic independence, although such an arrangement is not intended to be suggestive of limitation. As a user swivels the smaller mobile device 1805 (attempting to reposition the rear-view mirror, for example), leveraging the gyroscope sensor, the smaller mobile device 1805 communicatively alerts the positional change to the primary tablet 1804 device by wireless exchange, leading the primary tablet 1804 device to adjust or update the field of view on the “rear-view” mirror, accordingly. Said adjustment in the field of view is permitted to occur in real-time via an updated directive sent to the smaller mobile device 1805 for related processing (hardware and software based).

The racing-wheel controller 1800 comprises a processor and micro-controller system that, amongst other capabilities, is capable of tracking directional racing-wheel motion for immediate communicable relay to the primary user device, or tablet 1804 according to this embodiment, for directional integration into the game-play as it is being rendered. The racing-wheel controller 1800 may be powered by a voltage source or a current source. The racing-wheel controller 1800 may not rely on the influence of user-supplied capacitance traditionally associated with a touchscreen controller input (that is, a user-supplied capacitive input may not be integral to the operability of a racing-wheel controller 1800 input according to an embodiment), or, in divergent iterations, at least in some propensity, a racing-wheel controller 1800 input may rely on an attachable capacitive discharge overlay that may be governed by the capacitive input of a user. The racing wheel 1806 of the racing-wheel controller 1800 may be designed, for instance, to be fluently integrated, accounting for a full-range of motion entitlement, to a traditional soft-button input system of a touchscreen according to a prescribed mapping infrastructure advanced or may see associated software only offering the availability of certain features to a physical-controller system, such as this, that yields directional input not represented by a soft-controller or soft-input system; users may thus be presented with controller options prior to game commencement. Such controller designs as this, for example, may change the way a game is programmed for controllability. A paradigm shift in thinking beyond the simple (and “plain-vanilla”) control input of a finger.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. For possible attachment interjection in an associated controller environment, the reader may refer to the related teachings of an attachable capacitive-discharge overlay and/or an intermediary-transceiver device with attachable capacitive-discharge overlay; which may be introduced in divergent operating scenarios to this controller embodiment. The capacitive-discharge overlay may stem from the racing-wheel controller 1800 through a ramifying interface; operating under the ascendency of an internal capacitive management and distribution system (and/or by a capacitive charged supplied by a user) in accordance with an ancillary controller environment (not the subject of illustration).

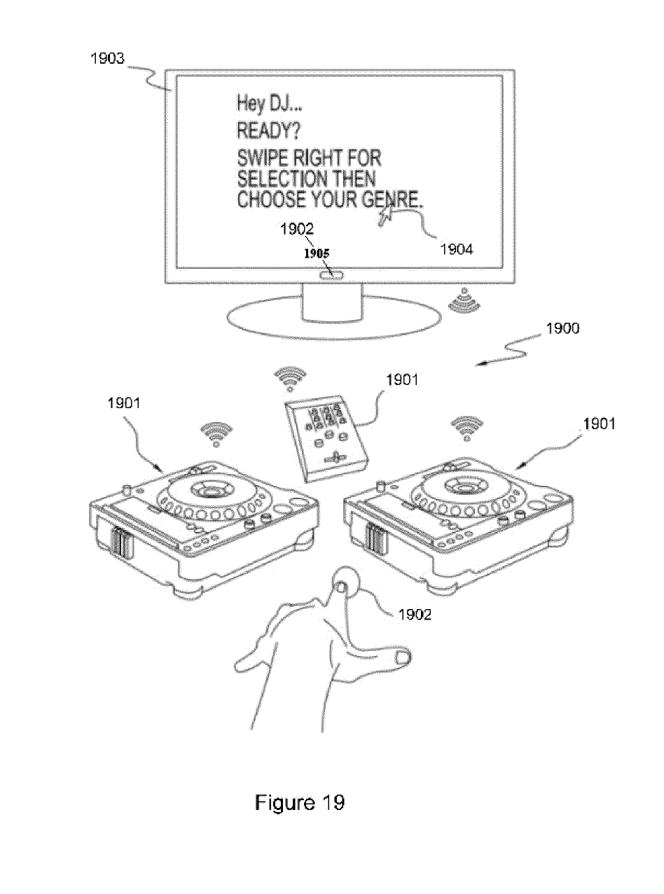

FIG. 19 illustrates a physical-intangible hybrid input-controller system 1900 utilizing both a physical-input controller 1901 and an intangible-input controller 1902 interface. The intangible-input controller 1902 operates under the influence of a user's gesture input (generally without a tactile, physical reference afforded to the user); the gesturing mapped by an integrated camera 1905 (and the associative software) of a touchscreen user-device 1903 remote from the user, this according to an embodiment. Exemplifying a case of gesture input in the spirit and scope of this discourse—while acknowledging that many serviceable replacements of divergent systems tracking a gesture input are possible from that suggested in this embodiment—leads to the disclosure of a physical-intangible hybrid input-controller system 1900 or DJ-input controller system 1900 for a touchscreen environment.

Under this operating scenario, upon the launching of a DJ-related software application, a user may, for instance, be given a selection of songs from which to choose from using hand-based gesturing as a method of controller input; this process of song selection being repeated for both DJ turntables 1901. Leveraging a virtual pointer 1904 shown on the touchscreen user-device 1903, according to an embodiment, a user is afforded an orientation point from which to commence and map an ensuing gesture for targeted actuation. In this way, a user may manipulate the virtual pointer 1904 to a specific location on the touchscreen of a touchscreen user-device 1903 (as the virtual pointer 1904 is refreshed in real-time on the touchscreen) by using the large touchscreen's 1903 video output as a visual reference aid in tracking his or her finger for a related controller input and/or input plurality. Therefore, in expanding on the example above regarding a process of song selection, a user may guide the virtual pointer 1904 over the song of choice for official selection and then may proceed to tap the finger down (not suggestive of limitation, as gesture mapping can be electronically calibrated and/or written in a highly-diverse footprint) to actuate the indicated choice. Well beyond the simple song selection referred to in this example, the virtual output may include a digital “dashboard” providing the user with various miscellaneous selective material to chose from to compliment the user experience, such as selecting a venue, DJ style, music-type or genre, DJ's name, or akin selective input, all potentially chosen using the finger-responsive (camera-tracked 1905) virtual pointer 1904. Hand gestures, such as an articulated left swipe, could readily be programmed or set to change a digital page in a reflex response to the gesture, for instance. Furthermore, effects such as, but not limited to, video sampling, interjecting sound and video bites reflecting appreciation from an enthusiastic crowd, camera pans, light shows, dance-offs, and the like, may also be added to a gaming environment to heighten the user experience. Of course, in a progressively intangible-controller environment variant, even the DJ turntables 1901 could be activated and engaged remotely by selective hand gesture, if so coveted, although for the embodiment under primary discussion, the turntables are controlled by a physical-controller interface in an effort to inject a greater sense of realism to the game play.

The physical-intangible hybrid input-controller system 1900 or DJ-controller system 1900, designed for more “hands-on” enthusiasts, connects and integrates, virtually, with a touchscreen user-device 1903 via a wireless capacity. The DJ-controller system 1900 further contains a CPU and controller system for managing the exchange of control-based directives between it and a communicable touchscreen user device; promoting real-time integration between a physical controller and the DJ-based software application running on the touchscreen user-device 1903. Thus, such deejay fundamentals as scratching, mixing, engaging a slider, etceteras on the physical controller can instantly translate into a reflex virtual rendering of the same. The act of scratching, in adding colour by example, may be readily tracked by any serviceable means, including the incorporation of sensors in the turntable element of the DJ-controller system 1900, capable of readily ascertaining direction, range of motion and the like. In this way, the stylish physical-input controller (DJ-controller system 1900) complements the intangible-controller system in a rather bold design stroke.

Attachment characteristics potentially attributed to the particular embodiment: While the following exemplary discourse may suggest a practicable application of an attachment interface, it is not intended to suggest limitation in any regard and/or does not necessarily imply a specific method and/or system of preferred operability. Any deviceful controller assembly described in the accompanying dissertation, may operate directly, in wireless mode under an established duplexing system, with its linked partner (e.g., a touchscreen user device by virtue of a serviceable mapping system), thereby potentially displacing the need for an attachable physical interface. For possible attachment interjection in an associated controller environment, the reader may refer to the related teachings of an attachable capacitive-discharge overlay and/or an intermediary-transceiver device with attachable capacitive-discharge overlay; which may be introduced in divergent operating scenarios to this controller embodiment. The capacitive-discharge overlay may stem from any serviceable component of the DJ-controller system 1900 through a ramifying interface; operating under the ascendency of an internal capacitive management and distribution system (and/or under the ascendency of user-supplied capacitance in manipulating a controller input), in accordance with an ancillary controller environment (not the subject of illustration).

I claim:

1. A controller apparatus for touchscreen operation, comprising:
a physical input interface comprising at least one manipulable input and configured to remotely manipulate a soft input of a touchscreen device by virtue of a complementary actuating agent;
the at least one physical input interface being tethered to a touchscreen input interface;
wherein manipulation of the at least one manipulable input is translated to actuation of a correlative soft input of the touchscreen device for controlling actionable content.

2. The apparatus of claim 1, wherein the input interface is a mouse input device.

3. The apparatus of claim 1, wherein the input interface is a touchpad input device.

4. The apparatus of claim 1, wherein the input interface is a skeet-ball based input device transitionally designed for virtual integration in a touchscreen environment.

5. The apparatus of claim 1, wherein the input interface is a basketball net for virtual integration in a touchscreen environment.

6. The apparatus of claim 1, wherein the input interface is a mini-golf pad for virtual integration in a touchscreen environment.

7. The apparatus of claim 1, wherein the input interface comprises a hybrid radio-wave controller device with a receiving slot for a touchscreen user device for bi-modal input ability; and,
wherein the bi-modal input is for manipulating at least one physical object in conjunction with at least one virtual object integrated on the same touchscreen-based playing field.

8. The apparatus of claim 1, wherein the input interface is an attachable and retractable keyboard apparatus comprising a compressible conductive surface for targeted manipulation of a virtual touchscreen-keyboard by targeted touch manipulation from a user.

9. The apparatus of claim 1, in combination with the touchscreen device, wherein the input interface communicates directly with the touchscreen device either wired or wirelessly.

10. The apparatus of claim 1, wherein the input interface comprises a receiving apparatus for the suspension of a touchscreen device.

11. The apparatus of claim 1, in combination with a tracking camera, wherein the input interface is operating in conjunction with a tracking camera for actionable or virtual integration in a touchscreen environment.

12. The apparatus of claim 11, wherein the input interface comprises a sensor disposition reliant on a camera-based tracking system and;
wherein a camera of the touchscreen device and/or an autonomous camera device is/are used for modal integration into a virtual touchscreen environment.

13. The apparatus of claim 1, wherein the input interface is manipulated by an agent other than the user's direct touch.

14. A panoramic display system for a touchscreen environment comprising:
at least two display mediums serviceably positioned around a user for dynamic display interaction with a virtual setting by said user.

15. The display system of claim 14, wherein the display content is based on projection of projectable content.

16. The display system of claim 14, wherein the display content is based on the wired or wireless transmission of content from a remote host device.

17. The display system of claim 16, wherein each display offers a unique rendering; with each independent rendering based on app-driven articulations by virtue of software hosted on a touchscreen user-device.

18. The display system of claim 17, wherein the renderable display content may be subject to correlative manipulation by a sensor-based input device, remotely.

19. A dock-connector assembly comprising:
an intermediary apparatus receiving a touchscreen device,
the intermediary apparatus supplying a dock-connector pinout assembly for said receiving device;
the dock-connector pinout assembly being wired in a manner that permits the furnishing of power to said intermediary apparatus by virtue of tapping into the touchscreen device's power source upon dock-connector engagement with a serviceable touchscreen device.

20. The dock-connector assembly in claim 19, where an intermediary apparatus is capable of being charged by an independent power source.
